(19) United States
(12) Patent Application Publication
(10) Pub. No.: US 2011/0236760 A1
(43) Pub. Date: Sep. 29, 2011

(54) Electrode for non-aqueous electrolyte secondary battery, method for producing the same, and non-aqueous electrolyte secondary battery

(75) Inventor: Hiroyuki Kobori, Tokyo-To (JP)

(73) Assignee: DAI NIPPON PRINTING CO., LTD., TOKYO-TO (JP)

(21) Appl. No.: 12/659,892

(22) Filed: Mar. 24, 2010

(51) Int. Cl. H01M 4/80; H01M 4/58; B05D 5/12

(52) U.S. Cl. 429/231.95; 429/235; 427/126.3; 427/126.6

(57) ABSTRACT

An electrode for a non-aqueous electrolyte secondary battery with which the non-aqueous electrolyte secondary battery can perform high output charge and discharge is provided. The electrode for a non-aqueous electrolyte secondary battery includes a current collector and an electrode active material layer containing active materials. The electrode active material layer has a structure in which the active material exists continuously with the active material particles binding to each other, and has a porous structure in which pores through which an electrolyte can pass are formed.

### CROSS-REFERENCE TO RELATED APPLICATION

The whole content of Japanese Patent Application No. 2008-252685 is incorporated herein by reference.

### BACKGROUND OF THE INVENTION

1. Field of the Invention

The present invention relates to an electrode for use in a non-aqueous electrolyte secondary battery such as lithium-ion secondary battery, to a method for producing the electrode for use in a non-aqueous electrolyte secondary battery, and to a non-aqueous electrolyte secondary battery.

2. Background Art

Non-aqueous electrolyte secondary batteries represented by lithium-ion secondary batteries have high energy density and high voltage, and do not cause the memory effect (a phenomenon in which a battery gradually loses its capacity when the battery is charged before the battery is completely discharged) on charge or discharge. The non-aqueous electrolyte secondary batteries are therefore used in various fields of portable devices, large-sized devices, and so forth. Further, in recent years, the use of secondary batteries in the fields of electric vehicles, hybrid vehicles, power tools, etc. that are needed to have high output characteristics has attracted public attention.

A non-aqueous electrolyte secondary battery is generally composed of a cathode, an anode, a separator, and an organic electrolyte. An electrode having an electrode active material layer formed by applying an electrode active material layer-forming solution to the surface of a current collector made of metal foil or the like is often used as the cathode and the anode.

The electrode active material layer-forming solution is a slurry prepared by kneading and/or dispersing in an organic solvent an active material that can discharge, a binder, and a conductive material (provided that when the active material has electrical conductivity, the conductive material may not be used), and other materials as needed. Using this electrode active material layer-forming solution, an electrode is formed in the following manner in such a conventional production method as is disclosed e.g., in paragraphs [0019] to [0026] of the specification of JP 2006-310010A, or in paragraphs [0051] to of the specification of JP 2006-107750A and Claim 1 attached to the specification. The electrode active material layer-forming solution is first applied to the surface of a current collector. Subsequently, the solution applied to the current collector surface is dried so as to form a coating film on the current collector. The coating film is pressed onto the current collector so as to form an electrode active material layer, whereby an electrode having thereon the electrode active material layer is obtained.

The active material to be incorporated in the electrode active material layer-forming solution is a particulate compound dispersible in the solution and hardly fixes (fixates) to the surface of a current collector when the solution is simply applied to the current collector surface. In addition, a coating film formed by applying an electrode active material layer-forming solution containing no binder to a current collector and drying the applied solution easily peels off the current collector. That is to say, by means of a binder, electrode active materials (electrode active material particles) are bound together and are also fixed to the surface of a current collector so as to form an electrode active material layer. Thus, a binder has been considered to be a substantially essential ingredient.

On the other hand, the above conductive material is used to ensure good electronic conduction between the active material in the active material layer and the current collector, thereby decreasing the volume resistivity of the active material layer itself.

As mentioned above, large-capacity secondary batteries have been developed in recent years for use particularly in the fields of electric vehicles, hybrid vehicles, power tools, etc. that are needed to have high output characteristics. Further, even secondary battery for use in relatively small-sized devices such as mobile phones are expected to have not only large capacity but also high output characteristics and high rate charge/discharge characteristics, since these devices tend to be provided with a greater number of functions. In order for secondary battery to attain high output and high-rate charge/discharge, they are needed to have decreased impedance. This is because high-impedance cells have some problems; for example, they cannot make the best use of their capacity on high-output discharge and high-rate charge.

In order to decrease the impedance of a secondary battery, decreasing the impedance of an electrode for the cell is effective. In order to achieve this, there has been discussed a technique which a thinner electrode active material layer is formed on an electrode so as to increase the electrode area. Non-aqueous electrolytes for use in lithium-ion secondary battery usually have higher resistivity than aqueous electrolytes. Therefore, in lithium-ion secondary battery, the following embodiment has been discussed from the beginning of their development: thinner electrodes with larger areas are used with the electrode gap decreased, as compared with other secondary battery such as lead accumulators.

However, when the presence of ingredients other than the active materials in the electrode active material layer is also taken into account, it is impossible to make the active material layer thinner without limitation. Practically, the lower limit of the thickness of active material layers in lithium-ion secondary battery has been about several tens micrometers.

### SUMMARY OF THE INVENTION

The present invention was accomplished in the light of the above circumstances. An object of the present invention is therefore to provide a non-aqueous electrolyte secondary battery capable of performing high output charge and discharge.

The inventor paid our attention on binders contained in conventional electrode active material layers as a factor that makes it physically difficult to obtain thinner electrode active material layers. As mentioned above, a binder has been used as a substantially essential ingredient of an electrode active material layer. However, due to the existence of a binder, an electrode active material layer has been bulky and thus has been large in thickness. Further, the inventor found the following problems: the existence of a binder between active materials makes the migration length of ions and electrons longer, and also makes the electrode active material layer lower in electrolyte permeability, decreasing the area of contact between an electrolyte and the active materials. In addition, the inventor considered that the existence of binders causing these problems is a negative factor in increasing the output of electrodes.

That is to say, the inventor considered that it is possible to realize a non-aqueous electrolyte secondary battery capable of performing high output charge and discharge by providing the following: an electrode for a non-aqueous electrolyte secondary battery that has an electrode active material layer formed without a binder and that can perform high output charge and discharge; and a method for producing a current collector having thereon an electrode active material layer, in which active materials are satisfactorily bound to the surface of a current collector without a binder so as to form an electrode active material layer that is fixed to the current collector and does not peel off the current collector easily.

The inventor found that an electrode active material layer fixed to the surface of a current collector with active materials binding to the current collector surface and also to each other in the absence of a binder can be obtained in the form of a much thinner film, and that with such an electrode active material layer, it is possible to realize an electrode for a non-aqueous electrolyte secondary battery, capable of attaining extremely high output. On the basis of this finding, the inventor accomplished the present invention, an electrode for non-aqueous electrolyte secondary battery and a non-aqueous electrolyte secondary battery using it.

The inventor also found the following: as a means of binding active materials together without a binder and binding (fixing) the active materials to the current collector surface, by applying, to the surface of a current collector, a solution containing lithium salt, a proper metal salt, and some additives to form a film and heating the film at a high temperature so as to form a lithium transition metal complex oxide on the current collector surface, it is possible to bind at least a part of the particles of the lithium transition metal complex oxide to each other and also to the current collector surface, thereby forming a layer that is excellent in adhesion. On the basis of this finding, the inventor accomplished the present invention, a method for producing an electrode for non-aqueous electrolyte secondary battery.

An electrode for a non-aqueous electrolyte secondary battery according to one aspect of the present invention comprises:
a current collector; and
an electrode active material layer including active materials, the electrode active material layer being formed on at least a part of a surface of the current collector,
wherein the electrode active material layer has a structure in which at least a part of the active materials binds to the surface of the current collector and the active materials partly bind to each other so that the active materials exist continuously, and is a porous layer having pores through which an electrolyte can pass.

In the electrode for a non-aqueous electrolyte secondary battery according to one aspect of the present invention, the active materials may be a lithium transition metal complex oxide.

Further, in the electrode for a non-aqueous electrolyte secondary battery according to one aspect of the present invention, the electrode active material layer may have a thickness within a range of 300 nm or more to 10 μm or less.

Furthermore, in the electrode for a non-aqueous electrolyte secondary battery according to one aspect of the present invention, the active materials may have a mean minimum particle diameter within a range of 10 nm or more to less than 100 nm, and a mean maximum particle diameter within a rage of 20 nm or more to less than 900 nm, where the mean minimum particle diameter is the mean value of five smallest measurements among measurements of the particle diameters of any 20 active materials chosen from the active materials included in the electrode active material layer, and the mean maximum particle diameter is the mean value of five greatest measurements among the measurements of the particle diameters of the 20 active materials.

Furthermore, in the electrode for a non-aqueous electrolyte secondary battery according to one aspect of the present invention, a percentage of discharge capacity retention may be 50% or more at a discharge rate of 50 C or more, when the percentage of discharge capacity retention at a discharge rate of 1 C is taken as 100%.

Furthermore, in the electrode for a non-aqueous electrolyte secondary battery according to one aspect of the present invention, the electrode active material layer may include a conductive material.

A method for producing an electrode for a non-aqueous electrolyte secondary battery according to one aspect of the present invention, comprises the steps of:
preparing an electrode active material layer-forming solution including, at least, one or more metal-element-containing compounds containing a metal selected from the group consisting of cobalt, nickel, manganese, iron, and titanium, and a lithium-element-containing compound;
applying the prepared electrode active material layer-forming solution to at least a part of a surface of a current collector so as to form a coating film; and heating the current collector having thereon the coating film so as to form a lithium transition metal complex oxide on the surface of the current collector, thereby forming an electrode active material layer,
wherein, in the step of heating the current collector having thereon the coating film, the coating film and the current collector are heated at a temperature of 150° C. or more under the condition that a heat source is placed on a coating-film-formed side of the current collector.

In the method for producing an electrode for a non-aqueous electrolyte secondary battery according to one aspect of the present invention,
the step of heating the current collector having thereon the coating film may include the steps of:
heating the coating film and the current collector at a temperature of 150° C. or more under the condition that a heat source is placed on a coating-film-formed side of the current collector; and
then heating the coating film and the current collector at a temperature of 150° C. or more under the condition that heat sources are placed on each side of the current collector having thereon the coating film.

A non-aqueous electrolyte secondary battery according to one aspect of the present invention comprises:
a cathode and an anode;
a separator placed between the cathode and the anode; and
an electrolyte including a non-aqueous solvent,
wherein at least one of the cathode and the anode is the electrode for a non-aqueous electrolyte secondary battery set forth in claim 1.

The present invention can realize a non-aqueous electrolyte secondary battery capable of performing high output charge and discharge.

### BRIEF DESCRIPTION OF THE DRAWINGS

FIG. 1 is an electron micrograph showing a cross-section of an electrode for a non-aqueous electrolyte secondary battery according to an embodiment of the present invention.

FIG. 2 is a measured result measured by an X-ray diffraction apparatus (XRD) regarding the active material layer in the electrode of Example 1.

FIG. 3 is a measured result measured by an X-ray diffraction apparatus (XRD) regarding the active material layer in the electrode of Example 8.

FIG. 4 is a measured result measured by an X-ray diffraction apparatus (XRD) regarding the active material layer in the electrode of Example 10.

FIG. 5 is a measured result measured by an X-ray diffraction apparatus (XRD) regarding the active material layer in the electrode of Example 11.

### DETAILED DESCRIPTION OF THE INVENTION

### Electrode for Non-Aqueous Electrolyte Secondary Battery

An electrode for a non-aqueous electrolyte secondary battery in an embodiment of the present invention will be described hereinafter. The electrode (electrode plate) for non-aqueous electrolyte secondary batteries comprises a current collector and an electrode active material layer fixed to the surface of the current collector, with active materials (active material agents, active material particles) partly binding (fixing) to the surface of the current collector and also binding at least partly to each other.

(Current Collector)

Any current collector that is usually used as a cathode current collector in an electrode for non-aqueous electrolyte secondary batteries can be used herein. For example, metal foil consisting of a single metal or a metal alloy, such as aluminum foil, a nickel foil, or a copper foil, or a highly conductive material such as a carbon sheet, a carbon plate, or a carbon textile, is favorably used as the current collector.

The current collector can have any thickness as long as the current collector can be used in a cathode (cathode plate) or an anode (anode plate) for a non-aqueous electrolyte secondary battery. It is however preferred that the thickness of the current collector be within a range of 10 to 100 μm, more preferably a range of 15 to 50 μm.

(Electrode Active Material Layer)

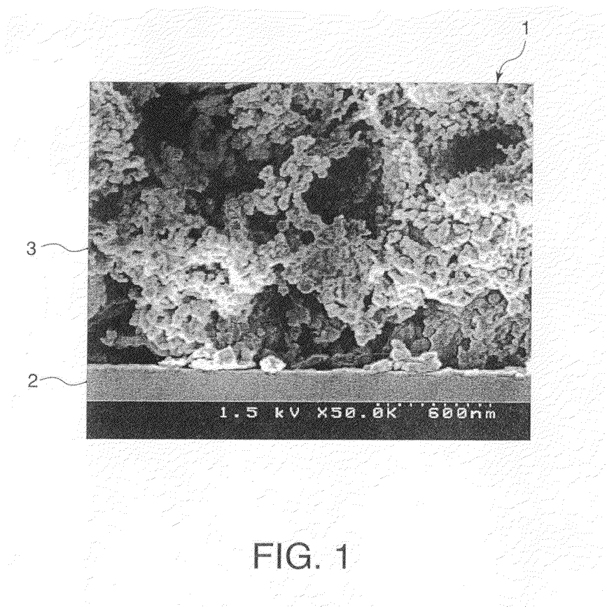

With reference to FIG. 1, the features of the electrode active material layer will be described. FIG. 1 is an electron micrograph at a magnification of ×50,000 of a cross-section of an electrode for non-aqueous electrolyte secondary batteries, which is taken vertically to the current collector plane in order to show the active material layer in the electrode. As shown in FIG. 1, in the electrode 1 for non-aqueous electrolyte secondary batteries, an electrode active material layer 3 made from active materials (active agents, active material particles) is present on a current collector 2. The electrode active material layer 3 has a structure in which the active materials exist continuously with the active materials partly binding to each other, and has a number of pores through which an electrolyte can pass.

The “pores through which an electrolyte can pass” regarding the electrode active material layer means pores which are formed around the active materials that partly bind to each other so as to form the electrode active material layer, and which are in such a size that the pores can be visually observed on an electron micrograph of the electrode active material layer at a magnification of ×50,000.

The electrode active material layer 3 is composed of active materials (active material agents, active material particles) that are usually used in an electrode for non-aqueous electrolyte secondary batteries, and that can discharge. Examples of such active materials include lithium transition metal complex oxides such as LiCoO₂, LiMn₂O₄, LiNiO₂, LiFeO₂, Li₄Ti₅O₁₂, LiNi_{1/3}Mn_{1/3}Co_{1/3}O₂, and LiFePO₄.

This electrode for non-aqueous electrolyte secondary batteries can be used as either the cathode or the anode for a non-aqueous electrolyte secondary battery. Alternatively, this electrode for non-aqueous electrolyte secondary batteries can be used as both the cathode and the anode. Particularly, the use of this electrode as a cathode is susceptible of wide application because various metal oxides can be used for the electrode, and is preferred because the electrode can be used in combination with a conventional anode. Further, the use of this electrode as an anode is preferred from the viewpoint that excellent cycle characteristics can be obtained because the electrode has good adhesion. On the other hand, when this electrode is used as both a cathode and an anode, high rate charge and discharge can be attained and excellent cycle characteristics can be obtained.

In the electrode for non-aqueous electrolyte secondary batteries in this embodiment, the active materials bind to each other and also to the surface of the current collector in the absence of a binder so as to form the electrode active material layer 3 that is fixed to the surface of the current collector. Therefore, it is possible to form, as the electrode active material layer 3, an extremely thin film much thinner than conventional electrode active material layers. More specifically, a thin film with a thickness within a range of 300 nm or more to 10 μm or less can be formed as the electrode active material layer 3. However, this description never excludes the formation of a film having a thickness of more than 10 μm as the electrode active material layer in this embodiment. In order to obtain an electrode further increased in capacity, the thickness of the electrode active material layer can be determined suitably. In the case where a film with a thickness of more than 10 μm is formed as the electrode active material layer in this embodiment, it is desirable to add a conductive material to a solution for forming the electrode active material layer (electrode active material layer forming solution).

The particle diameters of the active materials (active agents, active material particles) making up the electrode active material layer 3 in this embodiment are not limited to any value. However, the particle diameters of the active materials making up the electrode active material layer 3 in this embodiment are usually smaller than those of ordinary active materials making up conventional electrode active material layers. In order to make the output of the electrode higher, smaller particle diameters are preferred. From this point of view, the size of the active materials making up the electrode active material layer 3 is preferably as follows: the mean minimum particle diameter and the mean maximum particle diameter obtained by subjecting an electron microscopy image of the active material layer to a measurement using a software for image-analysis-type particle size distribution measurement (MAC VIEW manufactured by MOUNTECH CO., LTD., Japan) are 10 nm or more and less than 100 nm, and 20 nm or more and less than 900 nm, respectively. In particular, the mean maximum particle is preferably 20 nm or more and less than 300 nm. In accordance with the method for producing an electrode for non-aqueous electrolyte secondary batteries in this embodiment, which will be described later in detail, the electrode active material layer 3 can be easily formed from particles with the above-described extremely small particle diameters. In this specification, the mean minimum particle diameter of the active materials making up the electrode active material layer 3 is the mean value (average value) of five smallest measurements among measurements of the particle diameters of any 20 particles chosen from the active materials making up the electrode active material layer 3, and the mean maximum particle diameter is the mean value (average value) of five greatest measurements among the measurements of the particle diameters of the 20 active materials. Further, in this specification, the particle diameters of the active materials that are used to calculate the mean minimum particle diameter and the mean maximum particle diameter are the maximum lengths of the active materials on an electron microscopy image of the electrode active material layer 3 showing the section thereof along the normal direction to the surface of the current collector, measured using a software for image-analysis-type particle size distribution measurement (MAC VIEW manufactured by MOUNTECH CO., LTD., Japan).

When the active materials making up the electrode active material layer 3 have small particle diameters as described above, the electrode active material layer can have a surface area per weight unit larger than those of conventional electrode active material layers. The surface area of the electrode active material layer is understood as an area where the active materials and an electrolyte can contact. Therefore, increasing the surface area is preferred because it means the facilitation of the attainment of higher electrode output.

(Other Materials)

Although it is possible to form the electrode active material layer 3 only from the above-described active materials, additives may also be incorporated in the electrode active material layer 3 within the scope of the invention. For example, good electrical conductivity between the electrode active material layer 3 and the current collector 2 can be ensured without a conductive material in this embodiment, as is mentioned above, and this does not exclude the use of a conductive material in this embodiment. A conductive material may be contained in the electrode active material layer 3 in this embodiment, as needed. Even when a conductive material is added, a thin film with a thickness within a range of 10 μm or less can be formed as the electrode active material layer 3. Further, the thickness of the electrode active material layer 3 may be made more than 10 μm by adding a conductive material and also using an increased amount of the active materials.

Conductive materials that are usually used for electrodes for non-aqueous electrolyte secondary batteries can be used as the above conductive material. Examples of such conductive materials include carbon materials such as carbon black, e.g., acetylene black and ketjen black. It is preferred that the mean primary particle diameter of the conductive material be within a range of about 20 to 50 nm. The mean primary particle diameter is the arithmetic mean of particle diameters, where the maximum length of a particle, an object of measurement, on an electron microscopy image, measured using a software for image-analysis-type particle size distribution measurement (MAC VIEW manufactured by MOUNTECH CO., LTD., Japan), is taken as the particle diameter of the particle, like in the measurement of the particle diameters of the active materials. It is necessary to keep in mind that even if a conductive material is used, the electrode active material layer 3 should remain porous to such an extent that an electrolyte can permeate it.

For further improvement in the adhesion between the current collector and the active materials, a metal oxide that does not serve as an active material may also be contained in the electrode active material layer 3 as another additive. Any metal oxide can be used as the additive. Typical examples of metal oxides useful herein include cobalt oxide, nickel oxide, titanium oxide, zirconium oxide, tin oxide, and manganese oxide.

(Method for Evaluating Output of Electrode)

The output characteristics of an electrode for non-aqueous electrolyte secondary batteries can be evaluated by the percentage of discharge capacity retention (retention percentage of discharge capacity) (%). More specifically, the discharge rate 1 C is set so that the theoretical discharge capacity (mAh/g) of the active materials can be completely discharged in 1 hour, and the discharge capacity value (mAh/g) actually measured at the discharge rate 1 C is taken as 100% discharge capacity retention. Further, the discharge capacity value (mAh/g) is measured at an increased discharge rate, and the percentage of discharge capacity retention at each discharge rate can be obtained by using the following Equation 1:

[the percentage of discharge capacity retention(%)]=[the discharge capacity at an each discharge rate (mAh/g)]/[the discharge capacity at 1 C(mAh/g)] (Equation 1).

It is desirable that the percentage of discharge capacity retention of the electrode be 50% or more at a discharge rate of 50 C or more. It is more desirable that the percentage of discharge capacity retention be 50% or more at a discharge rate of 100 C or more. However, discharge rates of 2000 C or more are not desirable because such high discharge rates demand a system that can withstand heavy currents.

From another point of view, a higher percentage of discharge capacity retention is desirable, and it is desirable that the percentage of discharge capacity retention be 50% or more, preferably 80% or more, more preferably 100%, at a discharge rate of 50 C.

The above discharge capacity can be obtained by measuring the discharge capacity of the electrode itself placed in a three-electrode-type beaker cell.

The electrode for non-aqueous electrolyte secondary batteries according to this embodiment described above can ensure extremely high output characteristics. The following is considered to be at least one of the factors that make it possible for the electrode in this embodiment to attain high output: the active materials bind to the surface of the current collector in the absence of a binder, and thus the electrode active material layer is fixed to the current collector surface, so that the migration length of ions and electrons in the electrode active material layer in this embodiment is shorter than in conventional electrode active material layers.

Further, since substantially no binder is contained in the electrode active material layer in this embodiment, it is possible to form, as the electrode active material layer, a thin film with a thickness decreased within a rage from about 300 nm to 10 μm. Moreover, since no binder is present in the electrode active material layer in this embodiment, the relative unit weight of the active materials in the electrode active material layer is greater than in conventional electrode active material layers containing binders. Therefore, even if the electrode active material layer is in the form of a thinner film, the capacitance can be kept high.

Furthermore, due to the presence of the suitable pores, an electrolyte well permeates the electrode active material layer. In addition, due to the absence of a binder that may interfere with the behavior of ions, ions can move smoothly. It is considered that this makes it possible to attain high output charge and discharge. Further, conduction of electros between the current collector and the active material is smooth.

For this reason, the electrode active material layer in this embodiment can be formed without a binder and without even a conductive material. Even if containing no conductive material, the electrode active material layer can exhibit good electrical conductivity. Moreover, the active materials in the electrode active material layer is to have an increased relative unit weight because no conductive material is present, so that there can be obtained an electrode for non-aqueous electrolyte secondary batteries more excellent in high output charge and discharge characteristics.

On the other hand, a conductive material may be contained in the electrode active material layer in this embodiment in addition to the active materials. In the case where a conductive material is contained, the electrode active material layer is to have a thickness greater than the one consisting essentially of the active materials, but the amount of the active materials itself to be used can also be increased correspondingly. Thus, inclusion of a conductive material is advantageous in that it makes it possible to attain not only higher output but also greater capacitance.

[Method for Producing Electrode for Non-Aqueous Electrolyte Secondary Battery]

Next, a method for producing an electrode for non-aqueous electrolyte secondary batteries in this embodiment (hereinafter referred also to simply as a production method in this embodiment) will be described. In the production method in this embodiment, an electrode active material layer-forming solution is first prepared by dissolving a compound, precursors to active materials, in a solvent. This solution is applied to the surface of a current collector and is heated, whereby the solution forms active materials such as a lithium transition metal complex oxide on the current collector surface so as to form an electrode active material layer. In this manner, an electrode for non-aqueous electrolyte secondary batteries is produced. In this production method, substantially no binder is added to the electrode active material layer-forming solution; and making use of the phenomenon that the active materials bind to each other and also fix to the current collector surface upon the formation of the active material on the surface of the current collector, a coating film composed of the active materials bound to the current collector surface is formed. This method for producing an electrode for non-aqueous electrolyte secondary batteries will be described hereinafter more specifically.

(Precursor to Active Material)

The above electrode active material layer-forming solution uses, as a precursor to active material, metal-element-containing compounds containing metals that will make up the active material to be formed on the current collector surface, and the electrode active material layer-forming solution can be prepared by dissolving the metal-element-containing compounds in a solvent. The metal-element-containing compounds are a lithium-element-containing compound and one or more metal-element-containing compounds containing a metal element selected from cobalt, nickel, manganese, iron, and titanium.

Examples of the metal-element-containing compounds include chlorides, nitrates, sulfates, perchlorates, acetates, phosphates, and bromates of lithium element and of other metal elements such as cobalt. Of these compounds, chlorides, nitrates, and acetates of lithium element and of other metal elements are easily available as general-purpose products, so that it is preferable to use them. In particular, nitrates are excellent in the ability of forming films on various types of current collectors, so that they are favorably used.

For example, a combination of a Li compound and a Co compound, as main starting materials, can be used as precursor for finally forming LiCoO₂ on a current collector as active materials, and other materials can also be additionally used, as needed. Examples of the Li compound include lithium citrate tetrahydrate, lithium perchlorate trihydrate, lithium acetate dihydrate, lithium nitrate, and lithium phosphate. Examples of the Co compound include cobalt (II) chloride hexahydrate, cobalt (II) formate dihydrate, cobalt (III) acetylacetonate, cobalt (II) acetylacetonate dihydrate, cobalt (II) acetate tetrahydrate, cobalt (II) oxalate dihydrate, cobalt (II) nitrate hexahydrate, ammonium cobalt (II) chloride hexahydrate, sodium cobalt (III) nitrite, and cobalt (II) sulfate heptahydrate. Although no limitation is imposed on the ratio of the Li compound to the Co compound, Li:Co=X:1, it is preferred that X representing the Li to Co ratio be 1≦X<2, more preferably 1≦X≦12. When X is not in this range, there is a possibility that a cathode having the desired characteristics cannot be efficiently produced.

For example, a combination of a Li compound and a Ni compound, as main starting materials, can be used as precursor for finally forming LiNiO₂ on a current collector as active materials, and other materials can also be additionally used as needed. Examples of the Li compound include lithium citrate tetrahydrate, lithium perchlorate trihydrate, lithium acetate dihydrate, lithium nitrate, and lithium phosphate. Examples of the Ni compound include nickel (II) chloride hexahydrate, nickel (II) acetate tetrahydrate, nickel (II) perchlorate hexahydrate, nickel (II) bromide trihydrate, nickel (II) nitrate hexahydrate, nickel (II) acetylacetonate dihydrate, nickel (II) hypophosphite hexahydrate, and nickel (II) sulfate hexahydrate. Although no limitation is imposed on the ratio of the Li compound to the Ni compound, Li:Ni=X:1, it is preferred that X representing the Li to Ni ratio be 1≦X<2, more preferably 1≦X≦1.2. When X is not in this range, there is a possibility that a cathode having the desired characteristics cannot be efficiently produced.

For example, a combination of a Li compound and a Mn compound, as main starting materials, can be used as precursor for finally forming LiMn₂O₄ on a current collector as active materials, and other materials can also be additionally used as needed. Examples of the Li compound include lithium citrate tetrahydrate, lithium perchlorate trihydrate, lithium acetate dihydrate, lithium nitrate, and lithium phosphate. Examples of the Mn compound include manganese (III) acetate dihydrate, manganese (II) nitrate hexahydrate, manganese (II) sulfate pentahydrate, manganese (II) oxalate dihydrate, and manganese (III) acetylacetonate. Although no limitation is imposed on the ratio of the Li compound to the Mn compound, Li:Mn=X:1, it is preferred that X representing the Li to Mn ratio be 0.5≦X<1, more preferably 0.5≦X<0.6. When X is not in this range, there is a possibility that a cathode having the desired characteristics cannot be efficiently produced.

For example, a combination of a Li compound and an Fe compound, as main starting materials, can be used as precursor for finally forming LiFeO₂ on a current collector as active materials, and other materials can also be additionally used as needed. Examples of the Li compound include lithium citrate tetrahydrate, lithium perchlorate trihydrate, lithium acetate dihydrate, lithium nitrate, and lithium phosphate. Examples of the Fe compound include iron (II) chloride tetrahydrate, iron (III) citrate, iron (II) acetate, iron (II) oxalate dihydrate, iron (III) nitrate nonahydrate, iron (II) lactate trihydrate, and iron (II) sulfate heptahydrate. Although no limitation is imposed on the ratio of the Li compound to the Fe compound, Li:Fe=X:1, it is preferred that X representing the Li to Fe ratio be 1≦X<2, more preferably 1≦X≦1.2. When X is not in this range, there is a possibility that a cathode having the desired characteristics cannot be efficiently produced.

For example, a combination of a Li compound and a Ti compound, as main starting materials, can be used as precursor for finally forming Li₄Ti₅O₁₂ on a current collector as active materials, and other materials can also be additionally used as needed. Examples of the Li compound include lithium citrate tetrahydrate, lithium perchlorate trihydrate, lithium acetate dihydrate, lithium nitrate, and lithium phosphate. Examples of the Ti compound include titanium tetrachloride and titanium acetylacetonate. Although no limitation is imposed on the ratio of the Li compound to the Ti compound, Li:Ti=X:1, it is preferred that X representing the Li to Ti ratio be 0.5≦X<1, more preferably 0.7≦X≦1. When X is not in this range, there is a possibility that a cathode or an anode having the desired characteristics cannot be efficiently produced.

For example, a combination of a Li compound, a P compound, and an Fe compound, as main starting materials, can be used as precursor for finally forming LiFePO₄ on a current collector as active materials, and other materials can also be additionally used as needed. Examples of the Li compound include lithium citrate tetrahydrate, lithium perchlorate trihydrate, lithium acetate dihydrate, lithium nitrate, and lithium phosphate. Examples of the P compound include phosphoric acid, phosphorous acid, and diisopropyl phosphite. Examples of the Fe compound include iron (II) chloride tetrahydrate, iron (III) citrate, iron (II) acetate, iron (II) oxalate dihydrate, iron (III) nitrate nonahydrate, iron (II) lactate trihydrate, and iron (II) sulfate heptahydrate. Although no limitation is imposed on the ratio of the Li compound to the Fe compound, Li:Fe=X:1, it is preferred that X representing the Li to Fe ratio be 1≦X<2, more preferably 1≦X≦1.2. When X is not in this range, there is a possibility that a cathode having the desired characteristics cannot be efficiently produced. It is preferred that LiFePO₄ to be finally formed on a current collector be in the olivine structure because olivine can be formed at a relatively low heating temperature.

For example, a combination of the above-described Li compound and two or more transition metal compounds, or a combination of the above-described Li compound and a compound consisting of two or more transition metals, can be used as the main starting material to form finally a lithium transition metal complex oxide containing two or more transition metals on a current collector, and other materials can also be additionally used as needed. For example, the above-described Li compounds, the above-described Ni compound, the above-described Mn compound, and the above-described Co compound, as starting materials, can be used in combination as precursor for finally forming a lithium transition metal complex oxide containing two or more transition metals, such as LiNi_{1/3}Mn_{1/3}CO_{1/3}O₂, on a current collector as active materials. Alternatively, the above-described Li and Ni compounds, and a compound composed of Mn and Co can be used in combination, for example, and other starting materials can also be additionally used, as needed.

It is preferred that the total concentration of the lithium element and the metal element other than Li in the above-described solution containing the lithium-element-containing compound and the compound containing a metal element other than lithium be in the range of 0.01 to 5 mol/L, particularly in the range of 0.1 to 2 mol/L. When this concentration is 0.01 mol/L or more, there can be obtained good adhesion between the current collector and the active materials formed on the surface of the current collector, and the active materials can firmly bind to each other. On the other hand, when the above concentration is 5 mol/L or less, the electrode active material layer-forming solution can retain a viscosity suitable for application to the current collector surface, so that the electrode active material layer-forming solution can form a uniform film.

(Other Additives)

In addition to the above-described metal-element-containing compounds, a conductive material or other additives may be added to the electrode active material layer-forming solution within the scope of the invention. The above-mentioned other materials that can be additionally contained in the electrode active material layer can be added to the electrode active material layer-forming solution as the conductive material and other additives.

If a conductive material is added to the electrode active material layer-forming solution, it is desirable that the amount of the conductive material to be added be within a range of 5 to 20 parts by weight for 100 parts by weight of the active materials to be formed on the surface of the current collector. However, this mention does not mean the exclusion of addition of a conductive material in an amount of more than 20 parts by weight, but means the following: the electrode active material layer in this embodiment exhibits excellent electrical conductivity because of its structure, so that the use of a conductive material in an amount of 20 parts by weight or less is enough to make the electrode active material layer excellent in electrical conductivity.

(Solvent)

Any solvent can be used to dissolve the lithium-element-containing compound and the metal-element-containing compound containing a metal other than lithium, as long as it can dissolve these two compounds. Examples of such solvents useful herein include lower alcohols having five or less carbon atoms, such as methanol, ethanol, isopropyl alcohol, propanol, and butanol; diketones such as acetyl acetone, diacetyl acetone, and benzoyl acetone; ketoesters such as ethyl acetoacetate, ethyl pyruvate, ethyl benzoyl acetate, and ethyl benzoyl formate; toluene; and mixtures of two or more of these solvents.

The electrode active material layer-forming solution prepared in the above-described manner is applied to any desired portion of the surface of the current collector by a conventional coating process such as printing, spin coating, dip coating, bar coating, or spray coating. When the current collector surface is porous, or has many irregularities, or is three-dimensional, it is also possible to apply the electrode active material layer-forming solution manually. It is preferable to subject the current collector to corona discharge treatment, oxygen plasma treatment, or the like in advance, because such treatment can further facilitate the formation of the electrode active material layer.

Although the amount of the electrode active material layer-forming solution to be applied to the current collector can be determined by the intended use of the electrode to be produced, and so on, an extremely thin film can be formed as the electrode active material layer in this embodiment, as is described above. In order to obtain a thinner film, the electrode active material layer-forming solution may be thinly applied to the current collector so that the dried electrode active material layer has a thickness within a range of about 300 nm to 10 μm. By applying the electrode active material layer-forming solution to the current collector in the above-described manner, there is formed an electrode active material layer-forming film containing the metal-element-containing compounds, as precursors to the active materials.

Subsequently, the current collector having thereon the electrode active material layer-forming film is heated. In this step, by heating the current collector at a temperature higher than the decomposition temperatures of the metal-element-containing compounds dissolved in the solution, a lithium transition metal complex oxide, active material, is formed on the surface of the current collector. Moreover, the active materials bind to each other and also to the current collector surface in the absence of a binder so as to form an electrode active material layer that is excellent in adhesion to the current collector. In the production method in this embodiment, for suitably forming the electrode active material layer, a heat source is placed on a coating-film-formed side of the current collector. A heat source may be placed on coating-film-formed side of the current collector in any manner. Alternatively, a hot plate heated at a suitable temperature may be placed with the heating surface of the hot plate in contact with the surface of the electrode active material layer-forming film formed on the current collector.

The heating temperature in the above process is determined by the type of the metal-element-containing compounds to be used. In general, however, when the electrode active material layer-forming film is heated to a temperature between 150° C. and 800° C., the metal-element-containing compounds decompose satisfactorily to form an active material. Any heating method can be employed. Examples of heating methods useful herein include a method using, as the heat source, a heating device selected from hot plates, ovens, furnaces, infrared heaters, halogen heaters, hot-air fans, and the like, and a method using, as the heat source, a combination of two or more devices selected from the above-enumerated ones. When the current collector used is in plane form, it is preferable to use a hot plate or the like.

Alternatively, as mentioned above, after the electrode active material layer-forming film has been heated, the current collector may be heated from each side thereof, i.e., on the side on which the film has been formed and on the side on which the film has not been formed, to a temperature between 150° C. and 800° C. When the current collector is heated from each side thereof, the heaters may be placed on each side of the current collector, for example. Alternatively, the current collector having thereon the electrode active material layer-forming film may be placed in a furnace or the like, to heat both sides of the current collector in the same environment.

As mentioned above, in the method for producing an electrode for non-aqueous electrolyte secondary batteries in this embodiment, a coating liquid containing lithium salt, a suitable metal salt, and some additives is applied to the surface of a current collector so as to form a film and the film formed is heated, unlike in the conventional production method wherein a coating liquid in which lithium transition metal complex oxide particles, as active materials, have been dispersed in advance is applied to the surface of a current collector so as to form a film, and the film is dried and is brought into pressure contact with the current collector surface. In the production method in this embodiment, a lithium transition metal complex oxide, as active materials, is formed on the surface of a current collector, and the active materials bind at least partly to each other and also to the current collector. It is therefore possible to form an electrode active material layer without using a binder.

Further, in the method for producing an electrode for non-aqueous electrolyte secondary batteries in this embodiment, a lithium transition metal complex oxide in the form of extremely small particles is formed on the surface of a current collector. Therefore, the electrode active material layer can have an increased surface area per weight unit. Consequently, the production method in this embodiment is advantageous also in that desirable capacitance can be ensured although the electrode active material layer is thin.

[Non-Aqueous Electrolyte Secondary Battery]

A non-aqueous electrolyte secondary battery usually comprises a cathode (cathode plate, positive plate), an anode (anode plate, negative plate), and a separator made of a polyethylene porous film or the like and placed between the cathode and the anode. The cathode, the anode, and the separator are placed in a container, and the container is sealed with its inside filled with a non-aqueous electrolyte.

(Electrode)

The characteristic feature of the non-aqueous electrolyte secondary battery in this embodiment is that it uses the above-described electrode for non-aqueous electrolyte secondary batteries in this embodiment (hereinafter referred also to simply as the electrode in this embodiment) as at least one of the cathode and the anode. When the anode is composed of a carbonaceous material, it has been common practice to incorporate a large amount of a conductive material to the cathode so that the cathode has increased electrical conductivity to match the anode. As a result, the cathode has decreased porosity and thus has decreased electrolyte permeability, so that it has been difficult to increase cell output. On the other hand, the electrode in this embodiment can attain high output, so that if this electrode is used as the cathode, it is possible to ensure good electrical conductivity and high output without using a large amount of a conductive material, or without using a conductive material at all, unlike in the conventional technique.

Further, in conventional non-aqueous electrolyte secondary battery has also existed an embodiment that the anode is formed using, as an anode active material, not a carbonaceous material but a material capable of occluding and releasing lithium ions, such as metal lithium or its alloy, tin, silicon, or an alloy thereof. In such an embodiment of conventional non-aqueous electrolyte secondary battery, it is possible to use positively the electrode in this embodiment of the invention as the anode to produce a non-aqueous electrolyte secondary battery.

Furthermore, the electrode in this embodiment can be used as both the cathode and the anode to compose a non-aqueous electrolyte secondary battery.

In the non-aqueous electrolyte secondary battery in this embodiment, if the electrode in this embodiment is used as one electrode of the cathode and the anode, a conventional electrode for use in non-aqueous electrolyte secondary battery can be used as the other electrode of the cathode and the anode.

A conventional cathode that can be used herein is one made in the following manner. A liquid prepared by dispersing active materials (active agents, active material particles) such as a lithium transition metal complex oxide, a conductive material, a binder, and so on is applied to at least a part of the surface of a current collector that can be used in the electrode in this embodiment, thereby forming a coating film; the coating film is dried and, if necessary, pressed onto the current collector so as to form a cathode.

On the other hand, a conventional anode that can be used herein is one made in the following manner. An anode-active material-layer-forming solution is applied to at least a part of the surface of a current collector made of e.g., electrolytic or rolled copper foil with a thickness within a range of about 5 to 50 μm so as to form a coating film; the coating film is dried and, if necessary, pressed onto the current collector so as to form an anode. In order to prepare the anode-active material-layer-forming solution, the following ingredients are usually dispersed and mixed: active materials (active agents, active material particles) composed of a carbonaceous material such as natural graphite, artificial graphite, amorphous carbon, carbon black, or any of these materials to which a different element is added, or an active materials (active agents, active material particles) such as a material capable of occluding and releasing lithium ions, e.g., metal lithium or its alloy, tin, silicon, or an alloy thereof; a binder; and, when necessary, other additives such as a conductive material.

(Non-Aqueous Electrolyte)

Any non-aqueous electrolyte that is usually used for non-aqueous electrolyte secondary batteries can be used as the non-aqueous electrolyte in this embodiment. Particularly, it is preferable to use a non-aqueous electrolyte prepared by dissolving lithium salt in an organic solvent.

Typical examples of the lithium salt include inorganic lithium salts such as LiClO₄, LiBF₄, LiPF₆, LiAsF₆, LiCl, and LiBr; and organic lithium salts such as LiB(C₆H₅)₄, LiN(SO₂CF₃)₂, LiC(SO₂CF₃)₃, LiOSO₂CF₃, LiOSO₂C₂F₅, LiOSO₂C₄F₉, LiOSO₂C₅F₁₁, LiOSO₂C₆F₁₃, and LiOSO₂C₇F₁₅.

Examples of the organic solvent to be used to dissolve the lithium salt include cyclic esters, chain esters, cyclic ethers, and chain ethers. Specific examples of the cyclic esters include propylene carbonate, butylene carbonate, γ-butyrolactone, vinylene carbonate, 2-methyl-γ-butyrolactone, acetyl-γ-butyrolactone, and γ-valerolactone. Specific examples of the chain esters include dimethyl carbonate, diethyl carbonate, dibutyl carbonate, dipropyl carbonate, methyl ethyl carbonate, methyl butyl carbonate, methyl propyl carbonate, ethyl butyl carbonate, ethyl propyl carbonate, butyl propyl carbonate, alkyl propionates, dialkyl malonates, and alkyl acetates. Specific examples of the cyclic ethers include tetrahydrofuran, alkyltetrahydrofurans, dialkyltetrahydrofurans, alkoxytetrahydrofurans, dialkoxytetrahydrofurans, 1,3-dioxolane, alkyl-1,3-dioxolanes, and 1,4-dioxolane. Specific examples of the chain ethers include 1,2-dimethoxyethane, 1,2-diethoxythane, diethyl ether, ethylene glycol dialkyl ethers, diethylene glycol dialkyl ethers, triethylene glycol dialkyl ethers, and tetraethylene glycol dialkyl ethers.

A suitable conventional structure can be selected for the structure of the battery (cell) to be produced using the above-described cathode, anode, separator, and non-aqueous electrolyte. For example, the following structure can be adopted: a cathode and an anode are spirally wound up with a separator made of a polyethylene porous film or the like between the cathode and the anode, and this one is placed in a battery container (cell container). Another useful structure is as follows: a cathode and an anode that have been cut into a desired shape are layered over each other with a separator between the cathode and the anode and are bound together, and this one is placed in a battery container (cell container). In either structure, after placing the cathode and the anode in the battery container, lead wire attached to the cathode is connected to a cathode terminal provided on an outer container. On the other hand, lead wire attached to the anode is connected to an anode terminal provided in the outer container. The battery container is filled with a non-aqueous electrolyte and sealed, thereby producing a non-aqueous electrolyte secondary battery.

Since the non-aqueous electrolyte secondary battery in this embodiment uses the above-described electrode for non-aqueous electrolyte secondary batteries in this embodiment as at least one of the cathode and the anode, it can ensure extremely high output characteristics.

### EXAMPLES

### Example 1

6.9 g of LiNO₃ (molecular weight: 68.95) and 29 g of Co(NO₃)₂.6H₂O (molecular weight: 291.03) were used as starting materials (solutes) for active materials. These starting materials were dissolved in 30 g of methanol, and to this solution was further added 0.2 g of polyethylene glycol 400. Using an Excel Auto-Homogenizer (manufactured by NIHONSEIKI Co., Ltd., Japan), the mixture was kneaded at 5000 rpm for 15 minutes, thereby preparing an electrode active material layer-forming solution. On the other hand, aluminum foil with a thickness of 15 μm was prepared as a current collector. The electrode active material layer-forming solution was applied to one surface of the current collector with a Meyer Bar (a bar around which piano wire is wound) in such an amount that an electrode active material layer to be finally formed would have a thickness of 1 μm, thereby forming an electrode active material layer-forming film. The current collector having thereon the electrode active material layer-forming film was slowly brought close to a hot plate heated at 400° C. from the side of the electrode active material layer-forming film so as to be brought into contact therewith, and maintained under these conditions for 10 minutes. Then, the current collector is placed in an electric furnace at normal temperatures, and then the temperature of the electric furnace was raised to 600° C., target temperature, over a period of five hours. Maintaining the electric furnace at the temperature, the current collector was heated for one hour and then removed from the electric furnace. In this manner, there was obtained an electrode for non-aqueous electrolyte secondary batteries according to the above-described embodiment, having an electrode active material layer suitable as a cathode active material layer, layered over the current collector. This electrode was cut into a piece in a predetermined size (length 2 cm×width 2 cm), thereby obtaining an electrode of Example 1. In the above heating process, a hot plate (manufactured by AS ONE Corporation, Japan) was used to heat the side of the electrode active material layer-forming film, and a muffle furnace (model P90, manufactured by Denken Co., Ltd., Japan) was used as the electric furnace so as to then heat the current collect from each side thereof.

<Adhesion Test>

Subjecting the electrode of Example 1 to the following adhesion test, the adhesion of the electrode active material layer to the current collector was evaluated and was rated in accordance with the following criteria. A pressure-sensitive adhesive tape, Cellotape (registered trademark, CT-15 manufactured by Nichiban Co., Ltd., Japan) was stuck on the surface of the electrode active material layer and then it was peeled. When the proportion of the area of the portion of the electrode active material layer transferred to the Cellotape when the Cellotape was removed from the electrode active material layer fixed on the current collector, to the area of the entire surface of the Cellotape stuck on the surface of the electrode active material layer was less than 30%, the adhesion was rated as ◯; when the proportion was 30% or more and less than 90%, the adhesion was rated as Δ; and when the proportion was 90 to 100%, the adhesion was rated as x. As for the electrode of Example 1, the adhesion was rated as ◯.

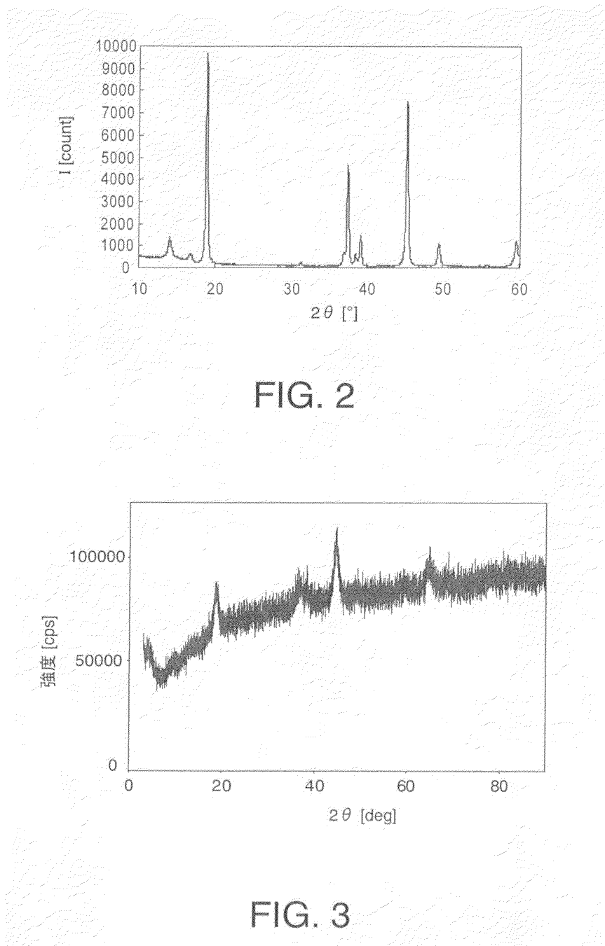

The electrode of Example 1 was left to stand until it was cooled to room temperature, and then it was sectioned vertically to the current collector surface. Observation of the cross-section was made with a scanning electron microscope (SEM) at a magnification of ×50,000 and also with an X-ray diffractometer (XRD), and the following were confirmed: a film composed of LiCoO₂ particles, having a thickness of 1 μm, was present on the surface of the current collector as the electrode active material layer; the LiCoO₂ particles partly bound to each other; and pores were formed therearound. Further, the particle diameters of twenty particles among the particles making up the electrode active material layer were measured on an electron micrograph taken in the above electron-microscopic observation, using a software for image-analysis-type particle size distribution determination (MAC VIEW manufactured by MOUNTECH CO., LTD., Japan). The mean value of five smallest measurements among the twenty measurements of the particle diameters was calculated as the mean minimum particle diameter, and the mean value of five greatest measurements among the twenty measurements of the particle diameters, as the mean maximum particle diameter. The mean minimum particle diameter was 24 nm, and the mean maximum particle diameter was 120 nm. An X-ray diffraction pattern of the electrode active material layer in the electrode of Example 1 is shown in FIG. 2. It was confirmed that the electrode active material layer in the electrode of Example 1 is composed of LiCoO₂, as is shown in FIG. 2. Incidentally, the existence of the particular electrode active material in the electrode active material layer in each one of the electrodes of Examples 2 to 6 was also confirmed by X-ray diffraction; however, the X-ray diffraction patterns obtained are not shown in the accompanying drawings.

<Preparation of Three-Electrode Beaker Cell>

A non-aqueous electrolyte was prepared by adding lithium phosphate hexafluoride (LiPF₆), solute, to a solvent mixture of ethylene carbonate (EC)/dimethyl carbonate (DMC) (=1:1 by volume), and adjusting the lithium phosphate hexafluoride concentration to 1 mol/L. The electrode of Example 1 (length 2 cm×width 2 cm, the weight of the cathode active materials contained: 1.0 mg/4 cm²) was used as the working electrode, cathode; a metal lithium plate made by bringing metal lithium foil into pressure contact with nickel mesh was used as the opposite and reference electrode; and the above-prepared non-aqueous electrolyte was used as the electrolyte. After attaching lead wire (nickel wire) to the electrodes (cathode, opposite electrode, and reference electrode) with the use of a spot welding machine, a three-electrode beaker cell was assembled, thereby obtaining a test cell of Example 1. This test cell was subjected to the following charge and discharge tests.

<Charge & Discharge Tests>

First of all, the test cell of Example 1, the three-electrode beaker cell prepared in the above-described manner, was fully charged in accordance with the procedure described under the following charge test, in order to carry out a working electrode discharge test.

Charge Test:

The test cell of Example 1 was charged at a constant current (52 μA) in an atmosphere at 25° C. until the voltage reached 4.2 V. After the voltage had reached 4.2 V, the current (discharge rate: 1 C) was reduced to 5% or less such that the voltage would not exceed 4.2 V, and constant-voltage charge was conducted until the test cell was fully charged. After this, the cell was rested for 10 minutes. The above “1 C” is the current value at which the three-electrode beaker cell discharges completely (the final discharge voltage is attained) in one hour when it is discharged at a constant current. The above constant current was set so that 130 mAh/g, the theoretical discharge capacity of lithium cobaltate, the active material on the working electrode in the test cell of Example 1, would be discharged in 1 hour.

Discharge Test:

The test cell of Example 1 that had been fully charged and then rested for 10 minutes was discharged at a constant current (52 μA) (discharge rate: 1 C) in an atmosphere at 25° C. until the voltage dropped from 4.2 V (full discharge voltage) to 3.0 V (final discharge voltage). Plotting cell voltage (V) as the ordinate and discharge time (h) as the abscissa, a discharge curve was drawn. Using this curve, the discharge capacity value (mAh) of the working electrode (the electrode of Example 1 for use as a cathode) was obtained; it was converted into the value of the discharge capacity per unit weight (mAh/g) of the working electrode.

Subsequently, on the basis of the constant-current discharge test carried out in the above-described manner at a constant current of 52 μA (discharge rate: 1 C, discharge completion time: 1 hour), constant-current discharge tests were carried out at a constant current of 1.04 mA, 20 times the above current (discharge rate: 20 C, discharge completion time: 3 minutes), at a constant current of 2.60 mA, 50 times the above current (discharge rate: 50 C, discharge completion time: 1.2 minutes), and at a constant current of 5.20 mA, 100 times the above current (discharge rate: 100 C, discharge completion time: 0.6 minutes). The discharge capacity values (mAh) of the working electrode at the respective discharge rates were obtained; they were converted into the values of discharge capacity per unit weight (mAh/g).

<Calculation of Percentages of Discharge Capacity Retention (%)>

To evaluate the output characteristics (discharge rate characteristics) of the working electrode, the percentages of discharge capacity retention were obtained by using the above Equation 1 and the above-obtained values of discharge capacity per unit weight (mAh/g) at the respective discharge rates. The values of discharge capacity per unit weight (mAh/g) at the respective discharge rates obtained from the above discharge tests and the percentages of discharge capacity retention calculated are collectively shown in Table 1.

### Comparative Example 1

80 parts by weight of LiCoO₂ powder with a mean particle diameter of 10 μm as starting material for cathode active materials, 10 parts by weight of acetylene black (Denka Black manufactured by Denki Kagaku Kogyo, Japan) as conductive material, and 10 parts by weight of PVDF (KF#1100 manufactured by KUREHA CORPORATION, Japan) as binder were added to and dispersed in an organic solvent NMP (manufactured by Mitsubishi Chemical Corporation, Japan), such that the solid content of the mixture would be 55% by weight. The mixture was stirred with an Excel Auto-Homogenizer (manufactured by NIHONSEIKI Co., Ltd., Japan) at 5000 rpm for 15 minutes. In this manner, a cathode-active material-layer-forming coating composition in slurry form was prepared. This cathode-active material-layer-forming coating composition was applied to one surface of 15 μm thick aluminum foil prepared as a cathode current collector such that the amount of the coating composition after dried would be 50 g/m², and was dried in an air oven at 120° C. for 20 minutes, thereby forming, on the surface of the current collector, an electrode active material layer for a cathode. Using a roll-pressing machine, the electrode active material layer was pressed so that a coating density of the electrode active material layer formed became 2.0 g/cm³ (the thickness of the cathode active material layer became 25 μm). After this, the current collector with the cathode active material layer was cut into a piece in a predetermined size (length 2 cm×width 2 cm), and this piece was dried at 120° C. for 12 hours under vacuum, thereby obtaining an electrode for use as a cathode for non-aqueous electrolyte secondary batteries, an electrode of Comparative Example 1. This electrode was subjected to the same adhesion test as in Example 1; the adhesion was rated as Δ.

<Preparation of Three-Electrode Beaker Cell>

A three-electrode beaker cell was assembled in the same manner as in Example 1, except that the electrode of Comparative Example 1 was used as the working electrode, thereby obtaining a test cell of Comparative Example 1.

<Charge Test & Discharge Test>

The test cell of Comparative Example 1 was subjected to the same charge and discharge tests as in Example 1, except that the constant currents at the respective discharge rates were changed to 1.2 mA (discharge rate: 1 C, discharge completion time: 1 hour), 23.4 mA (discharge rate: 20 C, discharge completion time: 3 minutes), 58.5 mA (discharge rate: 50 C, discharge completion time: 1.2 minutes), and 117.0 mA (discharge rate: 100 C, discharge completion time: 0.6 minutes). The discharge capacity values (mAh) of the working electrode at the respective discharge rates were obtained; they were converted into the values of discharge capacity per unit weight (mAh/g). Further, the percentages of discharge capacity retention were also obtained by using Equation 1 in the same manner as in Example 1. The results are collectively shown in Table 1.

### Example 2

An electrode active material layer-forming solution was prepared in the same manner as in Example 1, except that 6.9 g of LiNO₃ (molecular weight: 68.95) and 30 g of cobalt (II) acetylacetonate dihydrate (manufactured by Kanto Chemical Co., Inc., Japan) (molecular weight: 293.18) were used as starting materials (solutes) for active materials. An electrode active material layer-forming film was formed and heated in the same manner as and under the same conditions as in Example 1, except that an applicator 0.5 mil was used instead of the Meyer Bar to apply the electrode active material layer-forming solution to the current collector. By cutting the current collector having thereon the electrode active material layer, an electrode according to the above-described embodiment for use as a cathode for non-aqueous electrolyte secondary batteries, an electrode of Example 2, was obtained. This electrode was subjected to the same adhesion test as in Example 1; the adhesion was rated as ◯.

The electrode of Example 2 was left to stand until it was cooled to room temperature, and then it was sectioned vertically to the current collector surface. Observation of the cross-section was made in the same manner as in Example 1, and the following were confirmed: a film composed of LiCoO₂ particles, having a thickness of 1 μm, was present on the surface of the current collector as the electrode active material layer; the LiCoO₂ particles partly bound to each other; and pores were formed therearound. Further, the particle diameters of the particles making up the electrode active material layer were measured in the same manner as in Example 1; the mean minimum particle diameter was 22 nm, and the mean maximum particle diameter was 130 nm.

<Charge Test & Discharge Test>

A three-electrode beaker cell was assembled in the same manner as in Example 1, except that the electrode of Example 2 (length 2 cm×width 2 cm, the weight of the cathode active materials contained: 0.9 mg/4 cm²) was used as the working electrode, cathode, thereby obtaining a test cell of Example 2. This test cell was subjected to the same charge and discharge tests as in Example 1. The constant current used in the charge and discharge tests was 52 μA. The values of discharge capacity per unit weight (mAh/g) obtained from the discharge tests and the percentages of discharge capacity retention (%) calculated are collectively shown in Table 1.

### Example 3

An electrode active material layer-forming solution was prepared in the same manner as in Example 1, except that 3.3 g of LiNO₃ (molecular weight: 68.95) and 10 g of Co(NO₃)₂.6H₂O (molecular weight: 291.03) were used as starting materials (solutes) for active materials. An electrode active material layer-forming film was formed and heated in the same manner as and under the same conditions as in Example 1, except that the electrode active material layer-forming solution was applied in such an amount that an electrode active material layer to be finally formed would have a thickness of 300 nm. By cutting the current collector having thereon the electrode active material layer, an electrode according to the above-described embodiment for use as a cathode for non-aqueous electrolyte secondary batteries, an electrode of Example 3, was obtained. This electrode was subjected to the same adhesion test as in Example 1; the adhesion was rated as ◯.

The electrode of Example 3 was left to stand until it was cooled to room temperature, and then it was sectioned vertically to the current collector surface. Observation of the cross-section was made in the same manner as in Example 1, and the following were confirmed: a film composed of LiCoO₂ particles, having a thickness of 300 nm, was present on the surface of the current collector as the electrode active material layer; the LiCoO₂ particles partly bound to each other; and pores were formed therearound. Further, the particle diameters of the particles making up the electrode active material layer were measured in the same manner as in Example 1; the mean minimum particle diameter was 30 nm, and the mean maximum particle diameter was 140 nm.

<Charge Test & Discharge Test>

A three-electrode beaker cell was assembled in the same manner as in Example 1, except that the electrode of Example 3 (length 2 cm×width 2 cm, the weight of the cathode active materials contained: 0.35 mg/4 cm²) was used as the working electrode, cathode, thereby obtaining a test cell of Example 3. This test cell was subjected to the same charge and discharge tests as in Example 1. The constant current used in the charge and discharge tests was 20 μA. The values of discharge capacity per unit weight (mAh/g) obtained from the discharge tests and the percentages of discharge capacity retention (%) calculated are collectively shown in Table 1.

### Example 4

An electrode active material layer-forming solution was prepared in the same manner as in Example 1, except that 6.9 g of LiNO₃ (molecular weight: 68.95) and 29 g of Co(NO₃)₂.6H₂O (molecular weight: 291.03) were used as starting materials (solutes) for active materials, and that these starting materials were added to and dissolved in 18 g of methanol to form a solution, to which 20 g of polyethylene glycol 400 was further added. An electrode active material layer-forming film was formed and heated in the same manner as and under the same conditions as in Example 1, except that the electrode active material layer-forming solution was applied in such an amount that an electrode active material layer to be finally formed would have a thickness of 10 μm. By cutting the current collector having thereon the electrode active material layer, an electrode according to the above-described embodiment for use as a cathode for non-aqueous electrolyte secondary batteries, an electrode of Example 4, was obtained. This electrode was subjected to the same adhesion test as in Example 1; the adhesion was rated as ◯.

The electrode of Example 4 was left to stand until it was cooled to room temperature, and then it was sectioned vertically to the current collector surface. Observation of the cross-section was made in the same manner as in Example 1, and the following were confirmed: a film composed of LiCoO₂ particles, having a thickness of 10 μm, was present on the surface of the current collector as the electrode active material layer; the LiCoO₂ particles partly bound to each other; and pores were formed therearound. Further, the particle diameters of the particles making up the electrode active material layer were measured in the same manner as in Example 1; the mean minimum particle diameter was 98 nm, and the mean maximum particle diameter was 250 nm.

<Charge Test & Discharge Test>

A three-electrode beaker cell was assembled in the same manner as in Example 1, except that the electrode of Example 4 (length 2 cm×width 2 cm, the weight of the cathode active materials contained: 7.15 mg/4 cm²) was used as the working electrode, cathode, thereby obtaining a test cell of Example 4. This test cell was subjected to the same charge and discharge tests as in Example 1. The constant current used in the charge and discharge tests was 410 μA. The values of discharge capacity per unit weight (mAh/g) obtained from the discharge tests and the percentages of discharge capacity retention (%) calculated are collectively shown in Table 1.

### Example 5

An electrode active material layer-forming solution was prepared in the same manner as in Example 1, except that 6.9 g of LiNO₃ (molecular weight: 68.95) and 29 g of Co(NO₃)₂.6H₂O (molecular weight: 291.03) were used as starting materials (solutes) for active materials, and that these starting materials were added to and dissolved in 18 g of methanol to form a solution, to which 20 g of polyethylene glycol 400 and 1.2 g of acetylene black (Denka Black manufactured by Denki Kagaku Kogyo, Japan) were further added. An electrode active material layer-forming film was formed and heated in the same manner as and under the same conditions as in Example 1, except that the electrode active material layer-forming solution was applied in such an amount that an electrode active material layer to be finally formed would have a thickness of 10 μm, and that the heating conditions were changed. The heating condition for making the electrode of Example 5 was as follows. First, the current collector having thereon the electrode active material layer-forming film was slowly brought close to a hot plate heated at 300° C. from the side of the electrode active material layer-forming film so as to contact therewith, and maintained under these conditions for 10 minutes. Then, the current collector is placed in an electric furnace at normal temperature, and then the temperature of the electric furnace was raised to 550° C., target temperature, over a period of six hours. Maintaining the electric furnace at the temperature, the current collector was heated for one hour and then removed from the electric furnace. By cutting the heated current collector having thereon the electrode active material layer, an electrode according to the above-described embodiment for use as a cathode for non-aqueous electrolyte secondary batteries, an electrode of Example 5, was obtained. This electrode was subjected to the same adhesion test as in Example 1; the adhesion was rated as ◯.

The electrode of Example 5 was left to stand until it was cooled to room temperature, and then it was sectioned vertically to the current collector surface. Observation of the cross-section was made in the same manner as in Example 1, and the following were confirmed: a film composed of LiCoO₂ particles, having a thickness of 10 μm, was present on the surface of the current collector as the electrode active material layer; the LiCoO₂ particles partly bound to each other; and pores were formed therearound. Further, the particle diameters of the particles making up the electrode active material layer were measured in the same manner as in Example 1; the mean minimum particle diameter was 88 nm, and the mean maximum particle diameter was 190 nm.

<Charge Test & Discharge Test>

A three-electrode beaker cell was assembled in the same manner as in Example 1, except that the electrode of Example 5 (length 2 cm×width 2 cm, the weight of the cathode active materials contained: 6.9 mg/4 cm²) was used as the working electrode, cathode, thereby obtaining a test cell of Example 5. This test cell was subjected to the same charge and discharge tests as in Example 1. The constant current used in the charge and discharge tests was 390 μA. The values of discharge capacity per unit weight (mAh/g) obtained from the discharge tests and the percentages of discharge capacity retention (%) calculated are collectively shown in Table 1.

### Example 6

An electrode active material layer-forming solution was prepared in the same manner as in Example 1, except that 10.5 g of TiCl₄ (molecular weight: 189.68) and 3.06 g of LiNO₃ (molecular weight: 68.95) were used as starting materials (solutes) for active materials, and that 36 g of methanol was added to these starting materials, to which mixture was further added 42 g of polyethylene glycol 400. An electrode active material layer-forming film was formed and heated in the same manner as and under the same conditions as in Example 1, except that the electrode active material layer-forming solution was applied in such an amount that an electrode active material layer to be finally formed would have a thickness of 700 nm.

By cutting the current collector having thereon the electrode active material layer, an electrode according to the above-described embodiment for use as an anode for non-aqueous electrolyte secondary battery, an electrode of Example 6, was obtained. This electrode was subjected to the same adhesion test as in Example 1; the adhesion was rated as ◯.

The electrode of Example 6 was left to stand until it was cooled to room temperature, and then it was sectioned vertically to the current collector surface. Observation of the cross-section was made in the same manner as in Example 1, and the following were confirmed: a film composed of Li₄Ti₅O₁₂ particles, having a thickness of 700 was present on the surface of the current collector as the electrode active material layer; the Li₄Ti₅O₁₂ particles partly bound to each other; and pores were formed therearound. Further, the particle diameters of the particles making up the electrode active material layer were measured in the same manner as in Example 1; the mean minimum particle diameter was 11 nm, and the mean maximum particle diameter was 110 nm.

<Charge Test & Discharge Test>

A three-electrode beaker cell was assembled in the same manner as in Example 1, except that the electrode of Example 6 (length 2 cm×width 2 cm, the weight of the cathode active materials contained: 0.7 mg/4 cm²) made for use as an anode was used as the working electrode, thereby obtaining a test cell of Example 6. This test cell was subjected to the same charge and discharge tests as in Example 1. More specifically, the cell was charged at a constant current of 54 μA in an atmosphere at 25° C., until the voltage reached 1.3 V. After the voltage had reached 1.3 V, the current (discharge rate: 1 C) was reduced to 5% or less such that the voltage would not drop to below 1.3 V, and constant-voltage charge was conducted until the test cell was fully charged. After this, the cell was rested for 10 minutes. The above constant current was set so that 170 mAh/g, the theoretical discharge capacity of lithium titanate, the active material on the working electrode in the test cell of Example 6, would be discharged in 1 hour. Next, the test cell of Example 6 that had been fully charged and then rested for 10 minutes was discharged at a constant current (54 μA) (discharge rate: 1 C) in an atmosphere at 25° C. until the voltage dropped from 1.3 V (full discharge voltage) to 2.0 V (final discharge voltage). Plotting cell voltage (V) as the ordinate and discharge time (h) as the abscissa, a discharge curve was drawn. Using this curve, the discharge capacity value (mAh) of the working electrode (the electrode of Example 6 for use as an anode) was obtained; it was converted into the value of the discharge capacity per unit weight (mAh/g) of the working electrode. The values of discharge capacity per unit weight (mAh/g) obtained from the discharge tests and the percentages of discharge capacity retention (%) calculated are collectively shown in Table 1.

### Example 7

A three-electrode beaker cell was assembled in the same manner as in Example 1, using the electrode of Example 1 for use as a cathode and the electrode of Example 6 for use as an anode, thereby obtaining a test cell of Example 7. This test cell was subjected to the following charge and discharge tests. The constant current in the charge and discharge tests was 52 μA. The values of discharge capacity per unit weight (mAh/g) obtained from the discharge tests and the percentages of discharge capacity retention (%) calculated are collectively shown in Table 1.

<Charge Test & Discharge Test>

The test cell of Example 7 was charged at a constant current of 52 μA in an atmosphere at 25° C., until the voltage reached 3.3 V. After the voltage had reached 3.3 V, the current (discharge rate: 1 C) was reduced to 5% or less such that the voltage would not exceed 3.3 V, and constant-voltage charge was conducted until the test cell was fully charged. After this, the cell was rested for 10 minutes. Next, the test cell that had been fully charged and then rested for ten minutes was discharged at a constant current (52 μA) (discharge rate: 1 C) in an atmosphere at 25° C. until the voltage dropped from 3.3 V (full discharge voltage) to 1.0 V (final discharge voltage). Plotting cell voltage (V) as the ordinate and discharge time (h) as the abscissa, a discharge curve was drawn. Using this curve, the discharge capacity value (mAh) of the working electrode (the electrode of Example 1 for use as a cathode) was obtained; it was converted into the value of the discharge capacity per unit weight (mAh/g) of the working electrode.

### Comparative Example 2

An electrode of Comparative Example 2 for use as a cathode was made in the same manner as in Comparative Example 1, except that 7 parts by weight of PVDF (KF#1100 manufactured by KUREHA CORPORATION, Japan) was used as the binder. A test cell was assembled in the same manner as in Comparative Example 1, except that the electrode of Comparative Example 2 was used instead of the electrode of Comparative Example 1, thereby obtaining a test cell of Comparative Example 2. This test cell was evaluated in the same manner as in Comparative Example 1. The results of evaluation, such as the percentages of discharge capacity retention (%), are collectively shown in Table 1.

### Comparative Example 3

An experiment was carried out in the same manner as in Comparative Example 1, except that 0 part by weight of PVDF (KF#1100 manufactured by KUREHA CORPORATION, Japan) was used as the binder. Since no binder was contained, the electrode active material layer was not fixed to the current collector. It was therefore impossible to carry out the tests on the three-electrode beaker cell.

As shown in Table 1, the percentages of the discharge capacity retention of the test cells of Examples 1 to 6 and of Comparative Examples 1 and 2 were 100% at a discharge rate of 1 C. However, at increased discharge rates, the test cells of Comparative Examples 1 and 2 showed significantly decreased percentages of discharge capacity retention. This demonstrates that the test cells of Comparative Examples 1 and 2 are poor in charge and discharge characteristics. On the other hand, the test cells of Examples 1 to 6 had high percentages of discharge capacity retention even at increased discharge rates. Thus, it was confirmed to be certain that it is possible to improve charge and discharge characteristics by using an electrode according to the above-described embodiment.

The electrodes of Comparative Examples 1 and 2, different in the amount of the binder used, were compared. The electrode of Comparative Example 2, using a smaller amount of the binder, show better charge and discharge characteristics. This demonstrates that the existence of a binder is directly related to the charge and discharge characteristics of an electrode.

It was also confirmed that the test cell of Example 7 assembled using the electrode of Example 1 for use as a cathode and the electrode of Example 6 for use as an anode is excellent in charge and discharge characteristics. This demonstrates that non-aqueous electrolyte secondary battery using the electrodes according to the above-described embodiment are excellent in charge and discharge characteristics. That is to say, it can be said that the reason why the test cell of Example 7 has excellent charge and discharge characteristics is that the electrode of Example 6, anode, used as the opposite electrode, has high rate characteristics comparable to those of metal lithium, so that the performance of the electrode of Example 1, working electrode, was rated as excellent. Therefore, the test cell of Example 7 showed both the characteristics of the test cell of Example 1 and those of the test cell of Example 6, showing that the non-aqueous electrolyte secondary battery using these two electrodes is excellent in charge and discharge characteristics.

TABLE 1

| | | thickness | | | | | percentage | mean | mean |
|---|---|---|---|---|---|---|---|---|---|
| | | of electrode | | adhesion of | | | of discharge | minimum | maximum |
| | active | active material | | active material | | discharge | capacity | particle | particle |
| | material | layer (active | | layer to current | discharge | capacity | retention | diameter | diameter |
| | (precursor) | material) | binder | collector | rate | (mAh/g) | (%) | [nm] | [nm] |
| Example 1 | LiNO₃, | 1 μm | not | ∘ | 1C | 130 | 100 | 24 | 120 |
| | Co(NO₃)₂ | (LiCoO₂) | used | | 20C | 98 | 75 | | |
| | | | | | 50C | 81 | 62 | | |
| | | | | | 100C | 49 | 38 | | |
| Comparative | LiCoO₂ | 25 μm | used | Δ | 1C | 130 | 100 | commercially | |
| Example 1 | | (LiCoO₂) | | | 20C | 73 | 56 | available particles | |
| | | | | | 50C | 38 | 29 | 10 μm | |
| | | | | | 100C | 3 | 2 | | |
| Example 2 | LiNO₃, | 1 μm | not | ∘ | 1C | 130 | 100 | 22 | 130 |
| | Co | (LiCoO₂) | used | | 20C | 101 | 78 | | |
| | acetylacetonate | | | | 50C | 81 | 62 | | |
| | | | | | 100C | 42 | 32 | | |
| | | | | | 1C | 130 | 100 | 30 | 140 |
| Example 3 | LiNO₃, | 300 nm | not | ∘ | 20C | 118 | 91 | | |
| | Co(NO₃)₂ | (LiCoO₂) | used | | 50C | 94 | 72 | | |
| | | | | | 100C | 73 | 56 | | |
| Example 4 | LiNO₃, | 10 μm | not | ∘ | 1C | 130 | 100 | 98 | 250 |
| | Co(NO₃)₂ | (LiCoO₂) | used | | 20C | 73 | 56 | | |
| | | | | | 50C | 66 | 51 | | |
| | | | | | 100C | 42 | 32 | | |
| Example 5 | LiNO₃, | 10 μm | not | ∘ | 1C | 130 | 100 | 88 | 190 |
| | Co(NO₃)₂ | (LiCoO₂) | used | | 20C | 100 | 59 | | |
| | | | | | 50C | 65 | 50 | | |
| | | | | | 100C | 48 | 28 | | |
| Example 6 | TiCl₄, | 700 nm | not | ∘ | 1C | 170 | 100 | 11 | 110 |
| | LiNO₃ | (Li₄Ti₅O₁₂) | used | | 20C | 122 | 72 | | |
| | | | | | 50C | 69 | 59 | | |
| | | | | | 100C | 51 | 30 | | |
| Example 7 | — | — | not | ∘ | 1C | 130 | 100 | — | — |
| | | | used | | 20C | 99 | 76 | | |
| | | | | | 50C | 79 | 61 | | |
| | | | | | 100C | 48 | 37 | | |
| Comparative | LiCoO₂ | 25 μm | used | Δ | 1C | 130 | 100 | commercially | |
| Example 2 | | (LiCoO₂) | | | 20C | 88 | 68 | available particles | |
| | | | | | 50C | 44 | 34 | 10 μm | |
| | | | | | 100C | 16 | 12 | | |

| | | | | | | | | |
|---|---|---|---|---|---|---|---|---|
| Comparative | LiCoO₂ | none | not | x | 1C | — | — | commercially |
| Example 3 | | | used | | | | | available particles |
| | | | | | | | | 10 μm |

### Example 8

10.2 g of Li(CH₃COO).2H₂O (molecular weight: 102.02), 9.7 g of Ni(NO₃)₂.6H₂O (molecular weight: 290.8), 9.6 g of Mn(NO₃)₂.6H₂O (molecular weight: 287.0), 9.7 g of Co(NO₃)₂.6H₂O (molecular weight: 287.0), and 3 g of an acrylic resin (Olycox KC210 manufactured by Kyoeisha Chemical Co., Ltd., Japan) were used as starting materials (solutes) for active materials. These starting materials were added to and dissolved in 70 g of a solution consisting of water and isopropyl alcohol at proportion of water:isopropyl alcohol=2:1. The solution obtained was stirred at 70° C. with a Bioshaker at 200 rpm for 5 hours and then held at room temperature for 24 hours, thereby preparing an electrode active material layer-forming solution. On the other hand, aluminum foil with a thickness of 15 μm was prepared as a current collector. The electrode active material layer-forming solution was applied to one surface of the current collector with a Meyer Bar (a bar around which piano wire is wound) in such an amount that an electrode active material layer to be finally formed would have a thickness of 4 μm, thereby forming an electrode active material layer-forming film. The current collector having thereon the electrode active material layer-forming film was slowly brought close to a hot plate heated at 300° C. from the side of the electrode active material layer-forming film so as to be brought into contact therewith, and maintained under these conditions for 10 minutes. Then, the temperature was returned to room temperature, and the current collector was subsequently, atomospherically heated in an electric furnace to 600° C. over a period of 5 hours, and was held at the temperature for 5 hours. After the current collector had been cooled to room temperature, the furnace was opened, and the current collector was removed from the furnace. In this manner, there was obtained an electrode for non-aqueous electrolyte secondary batteries according to the above-described embodiment, having an electrode active material layer suitable as a cathode active material layer, layered over the current collector. This electrode was cut into a piece in a predetermined size (a circular disc with a diameter of 15 mm), thereby obtaining an electrode of Example 8. In the above heating process, a hot plate (manufactured by AS ONE Corporation, Japan) was used to heat the current collector from the side of the electrode active material layer-forming film, and a muffle furnace (model P90, manufactured by Denken Co., Ltd., Japan) was used as the electric furnace so as to then heat the current collector from each side thereof.

<Adhesion Test>

Subjecting the electrode of Example 8 to the following adhesion test, the adhesion of the electrode active material layer to the current collector was evaluated and was rated in accordance with the following criteria. A pressure-sensitive adhesive tape Cellotape (registered trademark, CT-15 manufactured by Nichiban Co., Ltd., Japan) was stuck on the surface of the electrode active material layer and then it was peeled. When the proportion of the area of the portion of the electrode active material layer transferred to the Cellotape when the Cellotape was removed from the electrode active material layer fixed on the current collector, to the area of the entire surface of the Cellotape stuck on the surface of the electrode active material layer was less than 30%, the adhesion was rated as ◯; when the proportion was 30% or more and less than 90%, the adhesion was rated as Δ; and when the proportion was 90 to 100%, the adhesion was rated as x. As for the electrode of Example 8, the adhesion was rated as ◯.

The electrode of Example 8 was left to stand until it was cooled to room temperature, and then it was sectioned vertically to the current collector surface. Observation of the cross-section was made with a scanning electron microscope (SEM) at a magnification of ×10,000 and also with an X-ray diffractometer (XRD), and the following were confirmed: a film composed of LiNi_{1/3}Mn_{1/3}CO_{1/3}O₂ particles, having a thickness of 4 μm, was present on the surface of the current collector as the electrode active material layer; LiNi_{1/3}Mn_{1/3}CO_{1/3}O₂ particles partly bound to each other; and pores were formed therearound. Further, the particle diameters of twenty particles among the particles making up the electrode active material layer were measured on an electron micrograph taken in the above electron-microscopic observation, using a software for image-analysis-type particle size distribution determination (MAC VIEW manufactured by MOUNTECH CO., LTD., Japan). The mean value of five smallest measurements among the twenty measurements of the particle diameters was calculated as the mean minimum particle diameter, and the mean value of five greatest measurements among the twenty measurements of the particle diameters, as the mean maximum particle diameter. The mean minimum particle diameter was 6 nm, and the mean maximum particle diameter was 29 nm. An X-ray diffraction pattern of the electrode active material layer in the electrode of Example 8 is shown in FIG. 3. It was confirmed that the electrode active material layer in the electrode of Example 8 is composed of LiNi_{1/3}Mn_{1/3}CO_{1/3}O₂, as is shown in FIG. 3.

<Preparation of Three-Electrode Coin Cell>

A non-aqueous electrolyte was prepared by adding lithium phosphate hexafluoride (LiPF₆), solute, to a solvent mixture of ethylene carbonate (EC)/dimethyl carbonate (DMC) (=1:1 by volume) and adjusting the lithium phosphate hexafluoride concentration to 1 mol/L. Using the electrode of Example 8 (a circular disc with a diameter of 15 mm, the weight of the anode active materials contained: 1.3 mg/1.77 cm²) as the working electrode, cathode, a metal lithium plate as the opposite and reference electrode, and the above-prepared non-aqueous electrolyte as the electrolyte, a three-electrode coin cell was assembled, thereby obtaining a test cell of Example 8. This test cell was subjected to the following charge and discharge tests.

<Charge & Discharge Tests>

First of all, the test cell of Example 8, the three-electrode coin cell prepared in the above-described manner, was fully charged in accordance with the procedure described under the following charge test, in order to carry out a working electrode discharge test.

Charge Test:

The test cell of Example 8 was charged at a constant current (72 μA) in an atmosphere at 25° C., until the voltage reached 4.2 V. After the voltage had reached 4.2 V, the current (discharge rate: 1 C) was reduced to 5% or less such that the voltage would not exceed 4.2 V, and constant-voltage charge was conducted until the test cell was fully charged. After this, the cell was rested for 10 minutes. The above “1 C” is the current value at which the three-electrode coin cell discharges completely (the final discharge voltage is attained) in one hour when it is discharged at a constant current. The above constant current was set so that 160 mAh/g, the theoretical discharge capacity of LiNi_{1/3}Mn_{1/3}CO_{1/3}O₂, the active material on the working electrode in the test cell of Example 8, would be discharged in 1 hour.

Discharge Test:

The test cell of Example 8 that had been fully charged and then rested for 10 minutes was discharged at a constant current (72 μmA) (discharge rate: 1 C) in an atmosphere at 25° C. until the voltage dropped from 4.2 V (full discharge voltage) to 3.0 V (final discharge voltage). Plotting cell voltage (V) as the ordinate and discharge time (h) as the abscissa, a discharge curve was drawn. Using this curve, the discharge capacity value (mAh) of the working electrode (the electrode of Example 8 for use as a cathode) was obtained; it was converted into the value of the discharge capacity per unit weight (mAh/g) of the working electrode.

Subsequently, on the basis of the constant-current discharge test carried out in the above-described manner at a constant current of 72 μA (discharge rate: 1 C, discharge completion time: 1 hour), constant-current discharge tests were carried out at a constant current of 0.72 mA, 5 times the above current (discharge rate: 5 C, discharge completion time: 12 minutes), at a constant current of 1.43 mA, 10 times the above current (discharge rate: 10 C, discharge completion time: 6 minutes), and at a constant current of 7.2 mA, 50 times the above current (discharge rate: 50 C, discharge completion time: 1.2 minutes). The discharge capacity values (mAh) of the working electrode at the respective discharge rates were obtained; they were converted into the values of discharge capacity per unit weight (mAh/g).

<Calculation of Percentages of Discharge Capacity Retention (%)>

To evaluate the output characteristics (discharge rate characteristics) of the working electrode, the percentages of discharge capacity retention were obtained by using the above Equation 1 and the above-obtained values of discharge capacity per unit weight (mAh/g) at the respective discharge rates. The values of discharge capacity per unit weight (mAh/g) at the respective discharge rates obtained from the above discharge tests and the percentages of discharge capacity retention calculated are collectively shown in Table 2.

### Example 9

10.2 g of Li(CH₃COO).2H₂O (molecular weight: 102.02), 23.8 g of NiCl₂.6H₂O (molecular weight: 237.69), and 5 g of polyethylene glycol 20000 (manufactured by Kanto Chemical Co., Inc., Japan) were used as starting materials (solutes) for active materials. These starting materials were added to and dissolved in 50 g of a solution consisting of water and ethanol at proportion of water:ethanol=2:1. The solution obtained was stirred at 70° C. with a Bioshaker at 200 rpm for 5 hours and then held at room temperature for 24 hours, thereby preparing an electrode active material layer-forming solution. On the other hand, aluminum foil with a thickness of 15 μm was prepared as a current collector. The electrode active material layer-forming solution was applied to one surface of the current collector with a Meyer Bar in such an amount that an electrode active material layer to be finally formed would have a thickness of 5 μm, thereby forming an electrode active material layer-forming film. The current collector having thereon the electrode active material layer forming film was slowly brought close to a hot plate heated at 300° C. from the side of the electrode active material layer-forming film so as to be brought into contact therewith, and maintained under these conditions for 5 minutes. Then, the temperature was returned to room temperature, and the current collector was subsequently, atmospherically heated in an electric furnace to 580° C. over a period of 5 hours, and was held at the temperature for 1 hour. After the current collector had been cooled to room temperature, the furnace was opened and the current collector was removed from it. In this manner, there was obtained an electrode for non-aqueous electrolyte secondary batteries according to the above-described embodiment, having an electrode active material layer suitable as a cathode active material layer, layered over the current collector. This electrode was cut into a piece in a predetermined size (a circular disc with a diameter of 15 mm), thereby obtaining an electrode of Example 9. In the above heating process, a muffle furnace (model P90, manufactured by Denken Co., Ltd., Japan) was used as the electric furnace, and both sides of the current collector placed in the furnace were heated equally. The electrode of Example 9 was subjected to the same adhesion test as in Example 8; the adhesion was rated as ◯.

The electrode of Example 9 was left to stand until it was cooled to room temperature, and then it was sectioned vertically to the current collector surface. Observation of the cross-section was made in the same manner as in Example 8, and the following were confirmed: a film composed of LiNiO₂ particles, having a thickness of 5 μm, was present on the surface of the current collector as the electrode active material layer; LiNiO₂ particles partly bound to each other; and pores were formed therearound. Further, the particle diameters of the particles making up the electrode active material layer were measured in the same manner as in Example 8: the mean minimum particle diameter was 13 nm, and the mean maximum particle diameter was 55 nm. It was confirmed by X-ray diffraction that the electrode active material layer in the electrode of Example 9 is composed of LiNiO₂.

<Charge Test & Discharge Test>

A three-electrode coin cell was assembled in the same manner as in Example 8, except that the electrode of Example 9 (a circular disc with a diameter of 15 mm, the weight of the cathode active materials contained: 1 mg/1.77 cm²) made for use as a cathode was used as the working cell, thereby obtaining a test cell of Example 9. This test cell was subjected to the same charge and discharge tests as in Example 8. More specifically, the test cell was charged at a constant current (65 μA) in an atmosphere at 25° C., until the voltage reached 4.2 V. After the voltage had reached 4.2 V, the current (discharge rate: 1 C) was reduced to 5% or less such that the voltage would not drop to below 4.2 V, and constant-voltage charge was conducted until the test cell was fully charged. After this, the cell was rested for 10 minutes. The above constant current was set so that 170 mAh/g, the theoretical discharge capacity of lithium nickelate, the active material on the working electrode in the test cell of Example 9, would be discharged in 1 hour. Next, the test cell of Example 9 that had been fully charged and then rested for 10 minutes was discharged at a constant current (65 μmA) (discharge rate: 1 C) in an atmosphere at 25° C. until the voltage dropped from 4.2 V (full discharge voltage) to 3.0 V (final discharge voltage). Plotting cell voltage (V) as the ordinate and discharge time (h) as the abscissa, a discharge curve was drawn. Using this curve, the discharge capacity value (mAh) of the working electrode (the electrode of Example 9 for use as a cathode) was obtained; it was converted into the value of the discharge capacity per unit weight (mAh/g) of the working electrode.

Subsequently, on the basis of the constant-current discharge test carried out in the above-described manner at a constant current of 65 μA (discharge rate: 1 C, discharge completion time: 1 hour), constant-current discharge tests were carried out at a constant current of 0.65 mA, 5 times the above current (discharge rate: 5 C, discharge completion time: 12 minutes), at a constant current of 1.30 mA, 10 times the above current (discharge rate: 10 C, discharge completion time: 6 minutes), and at a constant current of 6.5 mA, 50 times the above current (discharge rate: 50 C, discharge completion time: 1.2 minutes). The discharge capacity values (mAh) of the working electrode at the respective discharge rates were obtained; they were converted into the values of discharge capacity per unit weight (mAh/g).

<Calculation of Percentages of Discharge Capacity Retention (%)>

To evaluate the output characteristics (discharge rate characteristics) of the working electrode, the percentages of discharge capacity retention were obtained by using the above Equation 1 and the above-obtained values of discharge capacity per unit weight (mAh/g) at the respective discharge rates. The values of discharge capacity per unit weight (mAh/g) at the respective discharge rates obtained from the above discharge tests and the percentages of discharge capacity retention calculated are collectively shown in Table 2.

### Example 10

5.1 g of Li(CH₃COO).2H₂O (molecular weight: 102.02), 24.5 g of Mn(CH₃COO)₂O.4H₂O (molecular weight: 245.09), and 3 g of a methyl cellulose resin (Metolose 4000 manufactured by Shin-Etsu Chemical Co., Ltd., Japan) were used as starting materials (solutes) for active materials. These starting materials were added to and dissolved in 120 g of a solution consisting of water and isopropyl alcohol at a proportion of water:isopropyl alcohol=3:1. The solution obtained was stirred at 70° C. with a Bioshaker at 200 rpm for 5 hours and then held at room temperature for 24 hours, thereby preparing an electrode active material layer-forming solution. On the other hand, aluminum foil with a thickness of 15 μm was prepared as a current collector. The electrode active material layer-forming solution was applied to one surface of the current collector with an applicator in such an amount that an electrode active material layer to be finally formed would have a thickness of 8 μm, thereby forming an electrode active material layer-forming film. The current collector having thereon the electrode active material layer-forming film was slowly brought close to a hot plate heated at 250° C. from the side of the electrode active material layer-forming film so as to be brought into contact therewith, and maintained under these conditions for 2 minutes. Then, the temperature was returned to room temperature, and the current collector having thereon the electrode active material layer-forming film was subsequently, atmospherically heated in an electric furnace to 600° C. over a period of 3 hours and then held at the temperature for 2 hours. After the current collector had been cooled to room temperature, the furnace was opened and the current collector was removed from it. In this manner, there was obtained an electrode for non-aqueous electrolyte secondary batteries according to the above-described embodiment, having an electrode active material layer suitable as a cathode active material layer, layered over the current collector. This electrode was cut into a piece in a predetermined size (a circular disc with a diameter of 15 mm), thereby obtaining an electrode of Example 10. In the above heating process, a muffle furnace (model P90, manufactured by Denken Co., Ltd., Japan) was used as the electric air furnace, and both sides of the current collector placed in the furnace were heated equally. The electrode of Example 10 was subjected to the same adhesion test as in Example 8; the adhesion was rated as ◯.

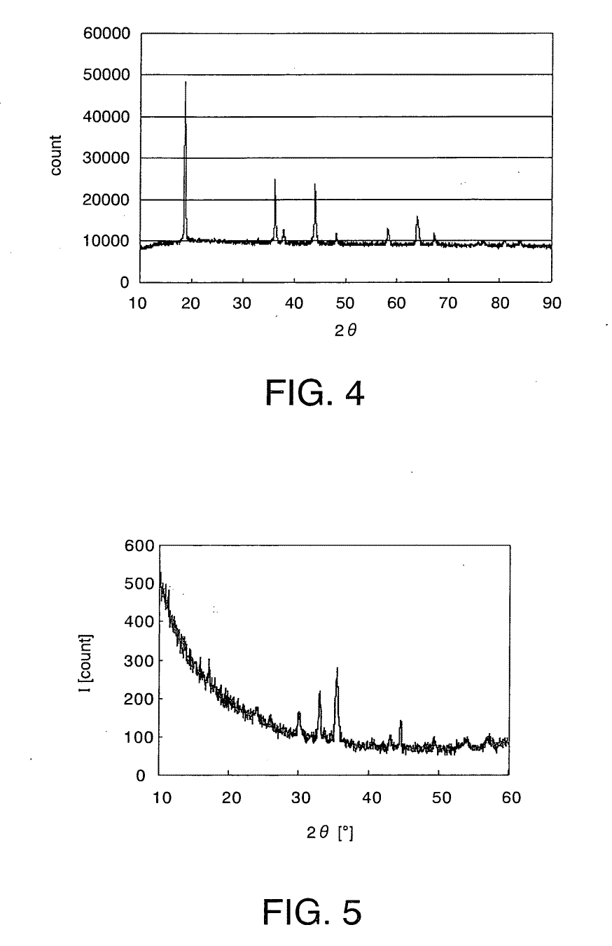

The electrode of Example 10 was left to stand until it was cooled to room temperature, and then it was sectioned vertically to the current collector surface. Observation of the cross-section was made in the same manner as in Example 8, and the following were confirmed: a film composed of LiMn₂O₄ particles, having a thickness of 8 μm, was present on the surface of the current collector as the electrode active material layer; LiMn₂O₄ particles partly bound to each other; and pores were formed therearound. Further, the particle diameters of the particles making up the electrode active material layer were measured in the same manner as in Example 8: the mean minimum particle diameter was 11 nm, and the mean maximum particle diameter was 62 nm. An X-ray diffraction pattern of the electrode active material layer in the electrode of Example 10 is shown in FIG. 4. It was confirmed that the electrode active material layer in the electrode of Example 10 is composed of LiMn₂O₄, as is shown in FIG. 4.

<Charge Test & Discharge Test>

A three-electrode coin cell was assembled in the same manner as in Example 8, except that the electrode of Example 10 (a circular disc with a diameter of 15 mm, the weight of the cathode active materials contained: 2.5 g/1.77 cm²) made for use as a cathode was used as the working electrode, thereby obtaining a test cell of Example 10. This test cell was subjected to the same charge and discharge tests as in Example 8. More specifically, the test cell was charged at a constant current (85 μA) in an atmosphere at 25° C., until the voltage reached 4.3 V. After the voltage had reached 4.3 V, the current (discharge rate: 1 C) was reduced to 5% or less such that the voltage would not drop to below 4.3 V, and constant-voltage charge was conducted until the test cell was fully charged. After this, the cell was rested for 10 minutes. The above constant current was set so that 90 mAh/g, the discharge capacity of lithium manganate, the active material on the working electrode in the test cell of Example 10, would be discharged in 1 hour. Next, the test cell of Example 10 that had been fully charged and then rested for 10 minutes was discharged at a constant current (85 μmA) (discharge rate: 1 C) in an atmosphere at 25° C. until the voltage dropped from 4.3 V (full discharge voltage) to 3.0 V (final discharge voltage). Plotting cell voltage (V) as the ordinate and discharge time (h) as the abscissa, a discharge curve was drawn. Using this curve, the discharge capacity value (mAh) of the working electrode (the electrode of Example 10 for use as an anode) was obtained; it was converted into the value of the discharge capacity per unit weight (mAh/g) of the working electrode. The value of discharge capacity per unit weight (mAh/g) obtained from the above discharge test, and the percentage of discharge capacity retention (%) calculated are collectively shown in Table 2.

Subsequently, on the basis of the constant-current discharge test carried out in the above-described manner at a constant current of 85 μA (discharge rate: 1 C, discharge completion time: 1 hour), constant-current discharge tests were carried out at a constant current of 0.85 mA, 5 times the above current (discharge rate: 5 C, discharge completion time: 12 minutes), at a constant current of 1.69 mA, 10 times the above current (discharge rate: 10 C, discharge completion time: 6 minutes), and at a constant current of 8.5 mA, 50 times the above current (discharge rate: 50 C, discharge completion time: 1.2 minutes). The discharge capacity values (mAh) of the working electrode at the respective discharge rates were obtained; they were converted into the values of discharge capacity per unit weight (mAh/g).

<Calculation of Percentages of Discharge Capacity Retention (%)>

To evaluate the output characteristics (discharge rate characteristics) of the working electrode, the percentages of discharge capacity retention were obtained by using the above Equation 1 and the above-obtained values of discharge capacity per unit weight (mAh/g) at the respective discharge rates. The values of discharge capacity per unit weight (mAh/g) at the respective discharge rates obtained from the above discharge tests and the percentages of discharge capacity retention calculated are collectively shown in Table 2.

### Comparative Example 4

80 parts by weight of LiNi_{1/3}Mn_{1/3}CO_{1/3}O₂ powder with a mean particle diameter of 10 μm as starting material for a cathode active materials, 10 parts by weight of acetylene black (Denka Black manufactured by Denki Kagaku Kogyo K.K., Japan) as conductive material, and 10 parts by weight of PVDF (KF#1100 manufactured by KUREHA CORPORATION, Japan) as binder were added to and dispersed in an organic solvent NMP (manufactured by Mitsubishi Chemical Corporation, Japan), such that the solid content of the mixture would be 55% by weight. The mixture was stirred with an Excel Auto-Homogenizer (manufactured by NIHONSEIKI Co., Ltd., Japan) at 5000 rpm for 15 minutes, thereby preparing an electrode active material layer-forming coating composition in slurry form. On the other hand, aluminum foil with a thickness of 15 μm was prepared as a cathode current collector. The electrode active material layer-forming coating composition was applied to one surface of the current collector such that the amount of the coating composition after dried would be 50 g/m², and was atmospherically dried in an oven at 120° C. for 20 minutes to form, on the surface of the current collector, an electrode active material layer for a cathode. The electrode active material layer was pressed onto the current collector by a roll-press machine so that a coating density of the electrode active material layer formed became 2.0 g/cm³ (the thickness of the cathode active material layer became 25 μm). After this, the current collector with the electrode active material layer was cut into a piece in a predetermined size (a circular disc with a diameter of 15 mm). This piece was dried at 120° C. for 12 hours under vacuum, thereby obtaining an electrode for use as a cathode for non-aqueous electrolyte secondary batteries, an electrode of Comparative Example 4. This electrode was subjected to the same adhesion test as in Example 8; the adhesion was rated as Δ.

<Production of Three-Electrode Coin Cell>

A three-electrode coin cell was assembled in the same manner as in Example 8, except that the electrode of Comparative Example 4 was used as the working cell, thereby obtaining a test cell of Comparative Example 4.

<Charge Test & Discharge Test>

The test cell of Comparative Example 4 was subjected to the same charge and discharge tests as in Example 8, except that the constant currents at the respective discharge rates were changed to 1.19 mA (discharge rate: 1 C, discharge completion time: 1 hour), 5.95 mA (discharge rate: 5 C, discharge completion time: 12 minutes), 11.9 mA (discharge rate: 10 C, discharge completion time: 6 minutes), and 59.5 mA (discharge rate: 50 C, discharge completion time: 1.2 minutes). The discharge capacity values (mAh) of the working electrode at the respective discharge rates were obtained; they were converted into the values of discharge capacity per unit weight (mAh/g). Further, the percentages of discharge capacity retention (%) were obtained by using Equation 1 in the same manner as in Example 8. The results are collectively shown in Table 2.

TABLE 2

| | | | | adhesion | | | | | |
|---|---|---|---|---|---|---|---|---|---|
| | | | | of active | | | percentage | mean | mean |
| | | | | material | | | of discharge | minimum | maximum |
| | | thickness of active | | layer to | | discharge | capacity | particle | particle |
| | active material | material layer | | current | discharge | capacity | retention | diameter | diameter |
| | (precursor) | (active material) | binder | collector | rate | (mAh/g) | (%) | [nm] | [nm] |
| Example 8 | Li(CH₃COO), | 4 μm | not | ∘ | 1C | 170 | — | 6 | 29 |
| | Ni(NO₃)₂, | (LiNi_{1/3}Co_{1/3}Mn_{1/3}O₂) | used | | 5C | 148 | 87 | | |
| | Mn(NO₃)₂, | | | | 10C | 124 | 73 | | |
| | Co(NO₃)₂ | | | | 50C | 87 | 51 | | |
| Example 9 | Li(CH₃COO), | 5 μm | not | ∘ | 1C | 147 | — | 13 | 55 |
| | NiCl₂ | (LiNiO₂) | used | | 5C | 136 | 93 | | |
| | | | | | 10C | 119 | 81 | | |
| | | | | | 50C | 101 | 69 | | |
| Example 10 | Li(CH₃COO), | 8 μm | not | ∘ | 1C | 92 | — | 11 | 62 |
| | Mn(CH₃COO)₂ | (LiMn₂O₄) | used | | 5C | 90 | 98 | | |
| | | | | | 10C | 89 | 97 | | |
| | | | | | 50C | 82 | 89 | | |
| Comparative | LiNi_{1/3}Co_{1/3}Mn_{1/3}O₂ | 25 μm | used | Δ | 1C | 173 | — | | |

| | | | | | |
|---|---|---|---|---|---|
| Example 4 | (LiNi_{1/3}Co_{1/3}Mn_{1/3}O₂) | 5C | 69 | 40 | commercially |
| | | 10C | 48 | 28 | available particles |
| | | 50C | 17 | 10 | 10 μm |

### Example 11

10.2 g of Li(CH₃COO).2H₂O (molecular weight: 102.02), 40.4 g of Fe(NO₃)₃.9H₂O (molecular weight: 404), 9.8 g of H₃PO₄ (molecular weight: 98), and 2 g of polyethylene oxide were used as starting materials (solutes) for active materials. These starting materials were added to and dissolved in 50 g of a mixture of 30 g of water and 15 g of methanol. The mixture obtained was stirred at 70° C. with a Bioshaker at 200 rpm for 1 hour to form an electrode active material layer-forming solution. In order to terminate the reaction of this solution completely, the solution was left to stand at room temperature for 24 hours. On the other hand, aluminum foil with a thickness of 15 pan was prepared as a current collector. The electrode active material layer-forming solution was applied to one surface of the current collector with a Meyer Bar (a bar around which piano wire is wound) in such an amount that an electrode active material layer to be finally formed would have a thickness of 20 μm, thereby forming an electrode active material layer-forming film. The current collector having thereon the electrode active material layer-forming film was slowly brought close to a hot plate heated at 250° C. in a nitrogen gas atmosphere from the side of the electrode active material layer-forming film so as to be brought into contact therewith, and maintained under these conditions for 2 minutes. Then, the temperature was returned to room temperature, and the current collector was subsequently heated in a baking furnace (manufactured by KOYO THERMO SYSTEMS, Japan) filled with nitrogen gas to 550° C. over a period of 5 hours and then held at the temperature for 1 hour. After the current collector had been cooled to room temperature, the furnace was opened and the cell was removed from it. In this manner, there was obtained an electrode for non-aqueous electrolyte secondary batteries according to the above-described embodiment, having an electrode active material layer suitable as a cathode active material layer, layered over the current collector. This electrode was cut into a piece in a predetermined size (a circular disc with a diameter of 15 mm), thereby obtaining an electrode of Example 11. In the above heating process, a hot plate (manufactured by AS ONE Corporation, Japan) was used to heat the current collector from the side of the electrode active material layer-forming film, and a gas-purge furnace (model KBF728 manufactured by KOYO THERMO SYSTEMS CO., LTD., Japan) was used as the baking furnace so as to then heat the current collector from each side thereof.

<Adhesion Test>

Subjecting the electrode of Example 11 to the following adhesion test, the adhesion of the electrode active material layer to the current collector was evaluated and was rated in accordance with the following criteria. A pressure-sensitive adhesive tape Cellotape (registered trademark, CT-15 manufactured by Nichiban Co., Ltd., Japan) was stuck on the surface of the electrode active material layer and then it was peeled. When the proportion of the area of the portion of the electrode active material layer transferred to the Cellotape when the Cellotape was removed from the electrode active material layer fixed on the current collector, to the area of the entire surface of the Cellotape stuck on the surface of the electrode active material layer was less than 30%, the adhesion was rated as ◯; when the proportion was 30% or more and less than 90%, the adhesion was rated as Δ; and when the proportion was 90 to 100%, the adhesion was rated as x. As for the electrode of Example 11, the adhesion was rated as ◯.

The electrode of Example 11 was sectioned vertically to the current collector surface. Observation of the cross-section was made with a scanning electron microscope (SEM) at a magnification of ×10,000 and also with an X-ray diffractometer (XRD), and the following were confirmed: a film composed of LiFePO₄ particles, having a thickness of 1 μm, was present on the surface of the current collector as the electrode active material layer; the LiFePO₄ particles partly bound to each other; and pores were formed therearound. Further, the particle diameters of twenty particles among the particles making up the electrode active material layer were measured on an electron micrograph taken in the above electron-microscopic observation, using a software for image-analysis-type particle size distribution determination (MAC VIEW manufactured by MOUNTECH CO., LTD., Japan). The mean value of five smallest measurements among the twenty measurements of the particle diameters was calculated as the mean minimum particle diameter, and the mean value of five greatest measurements among the twenty measurements of the particle diameters, as the mean maximum particle diameter. The mean minimum particle diameter was 12 nm, and the mean maximum particle diameter was 23 nm. An X-ray diffraction pattern of the electrode active material layer in the electrode of Example 11 is shown in FIG. 5. It was confirmed that the electrode active material layer in the electrode of Example 11 is composed of LiFePO₄, as is shown in FIG. 5.

<Preparation of Three-Electrode Coin Cell>

A non-aqueous electrolyte was prepared by adding lithium phosphate hexafluoride (LiPF₆), solute, to a solvent mixture of ethylene carbonate (EC)/dimethyl carbonate (DMC) (=1:1 by volume), and adjusting the lithium phosphate hexafluoride concentration to 1 mol/L. Using the electrode of Example 11 (a circular disc with a diameter of 15 cm, the weight of the anode active materials contained: 0.6 mg/1.77 cm²) as the working electrode, cathode, a metal lithium plate as the opposite and reference electrode, and the above-prepared non-aqueous electrolyte as the electrolyte, a three-electrode coin cell was assembled, thereby obtaining a test cell of Example 11. This test cell was subjected to the following charge and discharge tests.

<Charge & Discharge Tests>

First of all, the test cell of Example 11, the three-electrode coin cell prepared in the above-described manner, was fully charged in accordance with the procedure described under the following charge test, in order to carry out a working electrode charge test.

Charge Test:

The test cell of Example 11 was charged at a constant current (45 μA) in an atmosphere at 25° C., until the voltage reached 3.9 V. After the voltage had reached 3.9 V, the current (discharge rate: 1 C) was reduced to 5% or less such that the voltage would not exceed 3.9 V, and constant-voltage charge was conducted until the test cell was fully charged. After this, the cell was rested for 10 minutes. The above “1 C” is the current value at which the three-electrode coin cell discharges completely (the final discharge voltage is attained) in one hour when it is discharged at a constant current. The above constant current was set so that 150 mAh/g, the theoretical discharge capacity of iron lithium phosphate, the active material on the working electrode in the test cell of Example 11, would be discharged in 1 hour.

Discharge Test:

The test cell of Example 11 that had been fully charged and then rested for 10 minutes was discharged at a constant current (45 μA) (discharge rate: 1 C) in an atmosphere at 25° C. until the voltage dropped from 3.9 V (full discharge voltage) to 2.5 V (final discharge voltage). Plotting cell voltage (V) as the ordinate and discharge time (h) as the abscissa, a discharge curve was drawn. Using this curve, the discharge capacity value (mAh) of the working electrode (the electrode of Example 11 for use as a cathode) was obtained; it was converted into the value of the discharge capacity per unit weight (mAh/g) of the working electrode.

Subsequently, on the basis of the constant-current discharge test carried out in the above-described manner at a constant current of 45 μA (discharge rate: 1 C, discharge completion time: 1 hour), constant-current discharge tests were carried out at a constant current of 0.45 mA, 5 times the above current (discharge rate: 5 C, discharge completion time: 3 minutes), at a constant current of 0.9 mA, 10 times the above current (discharge rate: 10 C, discharge completion time: 1.2 minutes), and at a constant current of 4.5 mA, 50 times the above current (discharge rate: 50 C, discharge completion time: 0.6 minutes). The discharge capacity values (mAh) of the working electrode at the respective discharge rates were obtained; they were converted into the values of discharge capacity per unit weight (mAh/g).

<Calculation of Percentages of Discharge Capacity Retention (%)>

To evaluate the output characteristics (discharge rate characteristics) of the working electrode, the percentages of discharge capacity retention were obtained by using the above Equation 1 and the above-obtained values of discharge capacity per unit weight (mAh/g) at the respective discharge rates. The values of discharge capacity per unit weight (mAh/g) at the respective discharge rates obtained from the above discharge tests and the percentages of discharge capacity retention calculated are collectively shown in Table 3.

### Comparative Example 5

80 parts by weight of LiFePO₄ powder with a mean particle diameter of 10 μm as starting material for cathode active materials, 10 parts by weight of acetylene black (Denka Black manufactured by Denki Kagaku Kogyo K.K., Japan) as conductive material, and 10 parts by weight of PVDF (KF#1100 manufactured by KUREHA CORPORATION, Japan) as binder were added to and dispersed in an organic solvent NMP (manufactured by Mitsubishi Chemical Corporation, Japan), such that the solid content of the mixture would be 55% by weight. The mixture was stirred with an Excel Auto-Homogenizer (manufactured by NIHONSEIKI KAISHA, Japan) at 5000 rpm for 15 minutes, thereby preparing a cathode-active material-layer-forming coating composition in slurry form. On the other hand, aluminum foil with a thickness of 15 μm was prepared as a cathode current collector. The cathode active material layer forming coating composition was applied to one surface of the current collector such that the amount of the coating composition after dried would be 50 g/m², and was atmospherically dried in an oven at 120° C. for 20 minutes to form, on the surface of the current collector, an electrode active material layer for a cathode. The electrode active material layer was pressed onto the current collector by a roll-press machine so that a coating density of the electrode active material layer formed became 2.0 g/cm³ (the thickness of the cathode active material layer became 25 μm). The current collector with the cathode active material layer was cut into a piece in a predetermined size (a circular disc with a diameter of 15 mm). This piece was dried at 120° C. for 12 hours under vacuum, thereby obtaining an electrode for use as a cathode for non-aqueous electrolyte secondary batteries, an electrode of Comparative Example 5. This electrode was subjected to the same adhesion test as in Example 11; the adhesion was rated as Δ.

<Production of Three-Electrode Coin Cell>

A three-electrode coin cell was assembled in the same manner as in Example 11, except that the electrode of Comparative Example 5 was used as the working cell, thereby obtaining a test cell of Comparative Example 5.

<Charge Test & Discharge Test>

The test cell of Comparative Example 5 was subjected to the same charge and discharge tests as in Example 11, except that the constant currents at the respective discharge rates were changed to 1.2 mA (discharge rate: 1 C, discharge completion time: 1 hour), 6 mA (discharge rate: 5 C, discharge completion time: 12 minutes), 12 mA (discharge rate: 10 C, discharge completion time: 6 minutes), and 60 mA (discharge rate: 50 C, discharge completion time: 1.2 minutes). The discharge capacity values (mAh) of the working electrode at the respective discharge rates were obtained in the same manner as in Example 11; they were converted into the values of discharge capacity per unit weight (mAh/g). Further, the percentages of discharge capacity retention (%) were obtained by using Equation 1 in the same manner as in Example 11. The results are collectively shown in Table 3.

TABLE 3

| | | thickness | | adhesion | | | | | |
|---|---|---|---|---|---|---|---|---|---|
| | | of active | | of active | | | percentage | mean | mean |
| | | material | | material | | | of discharge | minimum | maximum |
| | active | layer | | layer to | | discharge | capacity | particle | particle |
| | material | (active | | current | discharge | capacity | retention | diameter | diameter |
| | (precursor) | material) | binder | collector | rate | (mAh/g) | (%) | [nm] | [nm] |
| Example 11 | Li(CH₃COO), | 1 μm | not | ∘ | 1C | 150 | 100 | 12 | 23 |
| | Fe(NO₃)₃ | (LiFePO₄) | used | | 5C | 141 | 94 | | |
| | | | | | 10C | 129 | 86 | | |
| | | | | | 50C | 105 | 70 | | |
| Comparative | LiFePO₄ | 25 μm | used | Δ | 1C | 150 | 100 | commercially | |
| Example 5 | | (LiFePO₄) | | | 5C | 72 | 48 | available particles | |
| | | | | | 10C | 38 | 25 | 10 μm | |
| | | | | | 50C | 15 | 10 | | |

1. An electrode for a non-aqueous electrolyte secondary battery, comprising:
a current collector; and
an electrode active material layer including active materials, the electrode active material layer being formed on at least a part of a surface of the current collector,
wherein the electrode active material layer has a structure in which at least a part of the active materials binds to the surface of the current collector and the active materials partly bind to each other so that the active materials exist continuously, and is a porous layer having pores through which an electrolyte can pass.

2. The electrode for a non-aqueous electrolyte secondary battery according to claim 1, wherein the active materials are a lithium transition metal complex oxide.

3. The electrode for a non-aqueous electrolyte secondary battery according to claim 1, wherein the electrode active material layer has a thickness within a range of 300 nm or more to 10 μm or less.

4. The electrode for a non-aqueous electrolyte secondary battery according to claim 1,
wherein the active materials have a mean minimum particle diameter within a range of 10 nm or more to less than 100 nm, and a mean maximum particle diameter within a range of 20 nm or more to less than 900 nm, where the mean minimum particle diameter is the mean value of five smallest measurements among measurements of the particle diameters of any 20 active materials chosen from the active materials included in the electrode active material layer, and the mean maximum particle diameter is the mean value of five greatest measurements among the measurements of the particle diameters of the 20 active materials.

5. The electrode for a non-aqueous electrolyte secondary battery according to claim 1,
wherein a percentage of discharge capacity retention is 50% or more at a discharge rate of 50 C or more, when the percentage of discharge capacity retention at a discharge rate of 1 C is taken as 100%.

6. The electrode for a non-aqueous electrolyte secondary battery according to claim 1,
wherein the electrode active material layer includes a conductive material.

7. A method for producing an electrode for a non-aqueous electrolyte secondary battery, comprising the steps of:
preparing an electrode active material layer-forming solution including, at least, a lithium-element-containing compound, and one or more metal-element-containing compounds containing a metal selected from the group consisting of cobalt, nickel, manganese, iron, and titanium;
applying the prepared electrode active material layer-forming solution to at least a part of a surface of a current collector so as to form a coating film; and
heating the current collector having thereon the coating film so as to form a lithium transition metal complex oxide on the surface of the current collector, thereby forming an electrode active material layer,
wherein, in the step of heating the current collector having thereon the coating film, the coating film and the current collector are heated at a temperature of 150° C. or more under the condition that a heat source is placed on a coating-film-formed side of the current collector.

8. The method for producing an electrode for a non-aqueous electrolyte secondary battery according to claim 7,
wherein the step of heating the current collector having thereon the coating film includes the step of:
heating the coating film and the current collector at a temperature of 150° C. or more under the condition that a heat source is placed on a coating-film-formed side of the current collector; and
then heating the coating film and the current collector at a temperature of 150° C. or more under the condition that heat sources are placed on each side of the current collector having thereon the coating film.

9. A non-aqueous electrolyte secondary battery comprising:
a cathode and an anode;
a separator placed between the cathode and the anode; and
an electrolyte including a non-aqueous solvent,
wherein at least one of the cathode and the anode is the electrode for a non-aqueous electrolyte secondary battery according to claim 1.
